SEQUENCE LISTING (6 sequences)

SEQ ID NO: 1 - protein, 269 aa, Bacillus clausii
AQSVPWGISRVQAPAAHNRGLTGSGVKVAVLDTGISTHPDLNIRGGASFVPGEPSTQDGNGHGTHVAGTIAALNNSIGVLGVAPSAELYAVKVLGASGSGSVSSIAQGLEWAGNNGMHVANLSLGSPSPSATLEQAVNSATSRGVLVVAASGNSGAGSISYPARYANAMAVGATDQNNNRASFSQYGAGLDIVAPGVNVQSTYPGSTYASLNGTSMATPHVAGAAALVKQKNPSWSNVQIRNHLKNTATSLGSTNLYGSGLVNAEAATR

SEQ ID NO: 2 - protein, 485 aa, Bacillus sp.
HHNGTNGTMMQYFEWYLPNDGNHWNRLRSDASNLKDKGISAVWIPPAWKGASQNDVGYGAYDLYDLGEFNQKGTIRTKYGTRNQLQAAVNALKSNGIQVYGDVVMNHKGGADATEMVRAVEVNPNNRNQEVSGEYTIEAWTKFDFPGRGNTHSNFKWRWYHFDGVDWDQSRKLNNRIYKFRGDGKGWDWEVDTENGNYDYLMYADIDMDHPEVVNELRNWGVWYTNTLGLDGFRIDAVKHIKYSFTRDWINHVRSATGKNMFAVAEFWKNDLGAIENYLNKTNWNHSVFDVPLHYNLYNASKSGGNYDMRQIFNGTVVQRHPMHAVTFVDNHDSQPEEALESFVEEWFKPLAYALTLTREQGYPSVFYGDYYGIPTHGVPAMKSKIDPILEARQKYAYGRQNDYLDHHNIIGWTREGNTAHPNSGLATIMSDGAGGNKWMFVGRNKAGQVWTDITGNRAGTVTINADGWGNFSVNGGSVSIWVNK

SEQ ID NO: 3 - protein, 773 aa, Bacillus sp.
AEGNTREDNFKHLLGNDNVKRPSEAGALQLQEVDGQMTLVDQHGEKIQLRGMSTHGLQWFPEILNDNAYKALANDWESNMIRLAMYVGENGYASNPELIKSRVIKGIDLAIENDMYVIVDWHVHAPGDPRDPVYAGAEDFFRDIAALYPNNPHIIYELANEPSSNNNGGAGIPNNEEGWNAVKEYADPIVEMLRDSGNADDNIIIVGSPNWSQRPDLAADNPINDHHTMYTVHFYTGSHAASTESYPPETPNSERGNVMSNTRYALENGVAVFATEWGTSQANGDGGPYFDEADVWIEFLNENNISWANWSLTNKNEVSGAFTPFELGKSNATNLDPGPDHVWAPEELSLSGEYVRARIKGVNYEPIDRTKYTKVLWDFNDGTKQGFGVNSDSPNKELIAVDNENNTLKVSGLDVSNDVSDGNFWANARLSADGWGKSVDILGAEKLTMDVIVDEPTTVAIAAIPQSSKSGWANPERAVRVNAEDFVQQTDGKYKAGLTITGEDAPNLKNIAFHEEDNNMNNIILFVGTDAADVIYLDNIKVIGTEVEIPVVHDPKGEAVLPSVFEDGTRQGWDWAGESGVKTALTIEEANGSNALSWEFGYPEVKPSDNWATAPRLDFWKSDLVRGENDYVAFDFYLDPVRATEGAMNINLVFQPPTNGYWVQAPKTYTINFDELEEANQVNGLYHYEVKINVRDITNIQDDTLLRNMMIIFADVESDFAGRVFVDNVRFEGAATTEPVEPEPVDPGEETPPVDEKEAKKEQKEAEKEEKEE

SEQ ID NO: 4 - protein, 524 aa, Paenibacillus polymyxa
VVHGQTAKTITIKVDTFKDRKPISPYIYGTNQDLAGDENMAARRLGGNRMTGYNWENNMSNAGSDWQQSSDNYLCSNGGLTQAECEKPGAVTTSFHDQSLKLGTYSLVTLPMAGYVAKDGNGSVQESEKAPSARWNQVVNAKNAPFQLQPDLNDNRVYVDEFVHFLVNKYGTASTKAGVKGYALDNEPALWSHTHPRIHGEKVGAKELVDRSVSLSKAVKAIDAGAEVFGPVLYGFGAYKDLQTAPDWDSVKGNYSWFVDYYLDQMRLSSQVEGKRLLDVFDVHWYPEAMGGGIRITNEVGNDETKKARMQAPRTLWDPTYKEDSWIAQWNSEFLPILPRLKQSVDKYYPGTKLAMTEYSYGGENDISGGIAMTDVLGILGKNDVYMANYWKLKDGVNNYVSAAYKLYRNYDGKNSTFGDTSVSAQTSDIVNSSVHASVTNASDKELHLVVMNKSMDSAFDAQFDLSGAKTYISGKVWGFDKNSSQIKEAAPITQISGNRFTYTVPPLTAYHIVLTTGNDTSPV

SEQ ID NO: 5 - protein, 399 aa, Bacillus subtilis [sequence omitted]

SEQ ID NO: 6 - protein, 490 aa, Bacillus sp. I633
LNNGFKKIFSITLSLLLASSILFVSGTSTANANSGFYVSGTTLYDANGNPFVMRGINHGHAWYKDQATTAIEGIANTGANTVRIVLSDGGQWTKDDIHTVRNLISLAEDNHLVAVPEVHDATGYDSIASLNRAVDYWIEMRSALIGKEDTVIINIANEWFGSWEGDAWADGYKQAIPRLRNAGLNHTLMVDAAGWGQFPQSIHDYGREVFNADPQRNTMFSIHMYEYAGGNASQVRTNIDRVLNQDLALVIGEFGHRHTNGDVDEATIMSYSEQRGVGWLAWSWKGNGPEWEYLDLSNDWAGNNLTAWGNTIVNGPYGLRETSRLSTVFTGGGSDGGTSPTTLYDFEGSMQGWTGSSLSGGPWAVTEWSSKGSHSLKADIQLSSNSQHYLHVIQNTSLQQNSRIQATVKHANWGSVGNGMTARLYVKTGHGYTWYSGSFVPINGSSGTTLSLDLSNVQNLSQVREIGVQFQSASDSSGQTSIYIDNVIVE

(19) United States
(12) Patent Application Publication
(10) Pub. No.: US 2015/0299622 A1
(43) Pub. Date: Oct. 22, 2015

(54) Enzyme Compositions Enabling Re-use of Water in Laundry

(71) Applicant: NOVOZYMES A/S, Bagsvaerd (DK)

(72) Inventors: Merete Faergemand, Alleroed (DK); Thomas Andersson, Kastrup (DK)

(21) Appl. No.: 14/440,420

(22) PCT Filed: Nov. 4, 2013
(86) PCT No.: PCT/EP2013/072932

§ 371 Date: May 4, 2015

Related U.S. Application Data
(60) Provisional application No. 61/723,021, filed on Nov. 6, 2012.

(30) Foreign Application Priority Data
Nov. 5, 2012 (EP) 12191282.8
Sep. 26, 2013 (EP) 13186240.1

(51) Int. Cl. C11D 3/386; C11D 11/00

(52) U.S. Cl. CPC C11D 3/386; C11D 3/38645; C11D 3/38636; C11D 3/38627; C11D 3/38654; C11D 11/0017

(57) ABSTRACT

Disclosed is a method for laundering textiles, where the wash liquor is reused in one or more wash cycles.

### REFERENCE TO A SEQUENCE LISTING

This application contains a Sequence Listing in computer readable form. The computer readable form is incorporated herein by reference.

### FIELD OF THE INVENTION

The present invention relates to laundry of fabrics and textiles with re-use of water, in particular manual laundry or cleaning.

### BACKGROUND OF THE INVENTION

Textiles are used in all countries in a vast variety of forms designs and amounts, but common for all countries is that wherever textiles are used there exists a need to clean the textiles to remove soils and stains that inevitable are attached to the textile during common daily activities. The vast majority of this cleaning is done in a laundry process using clean water and detergent, and since laundry is such a widespread operation that takes place in most homes worldwide laundry of textiles consumes large amounts of clean water.

In many countries water is a limited resource and it can be a challenge to find adequate supplies of clean water to meet the demand, and it is expected that the challenge will increase in the future both because of growing populations and as a result of that many natural water resources have been polluted as results of human activities.

There is therefore a desire to reduce the water consumption in general, and it would therefore be desirable to develop laundry method that uses less water but still provides for the same cleaning benefit.

### SUMMARY OF THE INVENTION

The invention relates to an improved method for laundering textiles and/or fabrics comprising the steps of:
a. Providing a wash liquor by dissolving/mixing a detergent composition and a multi enzyme composition in water;
b. Washing an aliquot of fabrics/textile in the wash liquor;
c. Repeating step b. one or more times with a new aliquot of fabrics/textiles so that wash liquor is used for 2 or more times; and
d. Optionally rinsing and drying the fabrics/textiles.

Preferably the method of the invention is a method for manual laundry.

The invention also relates to a multi enzyme composition to improve the cleaning benefit in a subsequent wash cycle, where the wash liquor is reused two or more times, and the use of such composition.

Further, the invention relates to detergent compositions for manual laundry, comprising a multi enzyme composition comprising two or more different enzymes and to such multi enzyme compositions.

### BRIEF DESCRIPTION OF DRAWINGS

FIG. 1 shows wash results on four swatches using two commercial detergents with and without added multi enzyme composition. The data confirms an improved washing effect by reusing wash liquor comprising multi enzyme composition.

FIG. 2 shows improved whiteness achieved by re-use of wash liquor comprising multi enzyme composition.

### DETAILED DESCRIPTION OF THE INVENTION

### Definitions

Textile: The term “textile” means any textile material including yarns, yarn intermediates, fibers, non-woven materials, natural materials, synthetic materials, and any other textile material, fabrics made of these materials and products made from fabrics (e.g., garments and other articles). The textile or fabric may be in the form of knits, wovens, denims, non-wovens, felts, yarns, and towelling. The textile may be cellulose based such as natural cellulosics, including cotton, flax/linen, jute, ramie, sisal or coir or manmade cellulosics (e.g. originating from wood pulp) including viscose/rayon, ramie, cellulose acetate fibers (tricell), lyocell or blends thereof. The textile or fabric may also be non-cellulose based such as natural polyamides including wool, camel, cashmere, mohair, rabbit and silk or synthetic polymers such as nylon, aramid, polyester, acrylic, polypropylene and spandex/elastane, or blends thereof as well as blends of cellulose based and non-cellulose based fibers. Examples of blends are blends of cotton and/or rayon/viscose with one or more companion material such as wool, synthetic fiber (e.g. polyamide fiber, acrylic fiber, polyester fiber, polyvinyl alcohol fiber, polyvinyl chloride fiber, polyurethane fiber, polyurea fiber, aramid fiber), and/or cellulose-containing fiber (e.g. rayon/viscose, ramie, flax/linen, jute, cellulose acetate fiber, lyocell). Fabric may be conventional washable laundry, for example stained household laundry. When the term fabric or garment is used it is intended to include the broader term textiles as well.

Aliquot of textile: The term “aliquot of textile” is intended to mean the amount of textile that generally is washed in one batch of wash liquor. An aliquot of textile may consist of one large piece of textile or it may consist of several smaller pieces of textiles.

Wash performance: The term “wash performance” is used as an enzyme's or mixture of enzymes' ability to remove stains present on the object to be cleaned during e.g. wash or hard surface cleaning.

Wash liquor: The term “wash liquor” is intended to mean the solution or mixture of water and detergents including enzymes used for laundering textiles.

Wash Cycle: The term “wash cycle” is intended to mean a batchwise washing operation where an aliquot of textile is immersed into wash liquor, mechanical action of some kind is applied to the textile in order to release stains and to facilitate flow of wash liquor in and out of the textile and finally removal of the superfluous wash liquor. After the wash cycle the textile is generally rinsed and dried.

Whiteness: The term “Whiteness” is defined herein as a broad term with different meanings in different regions and for different customers. Loss of whiteness can e.g. be due to greying, yellowing, or removal of optical brighteners/hueing agents. Greying and yellowing can be due to soil redeposition, body soils, colouring from e.g. iron and copper ions or dye transfer.

Whiteness might include one or several issues from the list below: colourant or dye effects; incomplete stain removal (e.g. body soils, sebum etc.); re-deposition (greying, yellowing or other discolourations of the object) (removed soils re-associates with other part of textile, soiled or unsoiled); chemical changes in textile during application; and clarification or brightening of colours.

“Colour clarification: During washing and wearing loose or broken fibers can accumulate on the surface of the fabrics. One consequence can be that the colours of the fabric appear less bright or less intense because of the surface contaminations. Removal of the loose or broken fibers from the textile will partly restore the original colours and looks of the textile. By the term “colour clarification”, as used herein, is meant the partial restoration of the initial colours of textile.”

### SEQUENCES

SEQ ID NO: 1 corresponds to the sequence of substilisin 309 disclosed in EP396608.

SEQ ID NO: 2 corresponds to SEQ ID NO: 12 disclosed in WO 2001/66712.

SEQ ID NO: 3 corresponds to SEQ ID NO: 2 disclosed in WO 2002/099091.

SEQ ID NO: 4 corresponds to SEQ ID NO 3 disclosed in WO 2009/147210.

SEQ ID NO: 5 corresponds to SEQ ID NO: 2 disclosed in WO2003/095638.

SEQ ID NO: 6 corresponds to SEQ ID NO: 2 disclosed in WO 99/64619.

### Method of the invention

The method of the invention relates to laundry of textile, in particular manual laundry of textiles where the wash liquor is reused two or more times, each time for washing a new aliquot or textile.

The wash liquor is according to the invention prepared in the traditionally way, by mixing or dissolving a detergent composition and a multi enzyme composition in water. Usually the detergent composition comprises the multi enzyme composition so in practice the invention is performed by mixing or dissolving the detergent composition comprising multi enzyme composition in water.

In general, the local water source is used in for preparing the wash liquor meaning that the water quality may vary significantly from one location to another. This is already well known in the field and it is further known that it may be recommendable to adapt the detergent composition to the local water quality and hardness etc. The skilled person will appreciate that this applies also for the present invention.

The temperature of the wash liquor may vary depending on the particular water source and is in general between the freezing point and the boiling point for water, however, for manual laundry the temperature is in general limited to temperatures where the user is not hurt by hot water. It is also well known that some fabrics are sensitive to high washing temperatures and for many textiles there is an upper limit for the washing temperatures e.g. at 30° C., 40° C. or 60° C.; that should be applied in order to avoid damaging the textiles. Typically the temperature of the wash liquor is therefore in the range of 0° C. and 60° C., more often in the range of 0° C. and 50° C., preferably in the range of 10° C. and 45° C., preferably in the range of 15° C. and 40° C., more preferred in the range of 20° C. and 30° C. The invention is not limited to any particular temperature ranges but it will be understood in the field that it is advisable to select the detergent ingredients and enzymes that are particular adapted to the intended wash temperature.

In manual laundry, textiles are washed in the wash water using a number of different actions such as dipping/immersing the textile in the wash liquor, soaking and usually some mechanical action to the textiles is order to release stains and facilitate flow of wash liquor in and out of the textile. When the washing steps are complete, superfluous wash liquor is removed, generally involving some kind of squeezing, the textile is rinsed, optionally treated in a post wash procedure e.g. by application of a fabric softener composition; and dried. Different users, habits and local traditions may also influence the actual used steps. The invention is not limited to any particular washing steps or procedures but it can be applied to any manual washing operation as long as the wash water can be retained after the wash cycle.

After the wash cycle the wash liquor will in addition to the constituents of the wash liquor contain the soils and stains that have been wash off the textile during the wash cycle. It will be appreciated that as the wash liquor have been used for and increasing number of wash cycles the amount of dirt in the wash liquor will also increase.

According to the invention, a subsequent wash cycle using a batch of wash liquor which has been used in at least one previous wash cycle is then performed using a new aliquot of textile in need of cleaning.

The wash liquor may according to the invention by used in two or more wash cycles, such as 2, 3, 4, 5, 6, 7, 8, 9, 10 or even more wash cycles. The re-use of wash liquor may continue until the time where the wash liquor contains so much soil that the amount of soil that is redeposited on the textiles reaches an unacceptable high level. Consequently, the maximal number of wash cycles that can be performed reusing same wash liquor depends on the actual conditions such as type of textiles, degree and nature of the stains etc.; for all tested conditions has the number of wash cycles that can be performed with satisfactory result been higher using the method of the invention using a wash liquor comprising a multi enzyme composition, compared with a similar wash cycle without a multi enzyme composition.

Using the method of the invention has the benefit that the wash performance is improved in each wash cycle meaning that the same wash liquor can be used for more laundering more textile aliquots with a satisfactory cleaning result, which again means that the water consumption pr textile aliquot is smaller, all compared to similar wash cycles using similar wash liquor but without a multi enzyme composition. The lower water consumption may also lead to a lower energy consumption since laundering often takes place at elevated temperature and therefore will a lower water consumption automatically mean that less water needs to be heated consequently leading to a reduced energy consumption.

The improved cleaning performance can be observed already in the first wash cycle but according to the invention the wash performance remains higher in the subsequent cycles. Even though it was known in the art that some enzymes have the ability to remove stains from textiles it was not expected that the multi enzyme composition of the invention also had the effect that the wash liquor could be used in more wash cycles since this is not solely connected with the ability to release stains but is also relates to the ability to prevent redeposition of soils.

Additionally, it has been observed that the improved performance using the method of the invention also apply to whiteness, so using the method of the invention also leads to improved whiteness even after two or more wash cycles, such as three or more wash cycles, such as four or more wash cycles, such as five or more wash cycles such as six or more wash cycles such as seven or more wash cycles such as eight or more wash cycles such as nine or more wash cycles or such as ten or more wash cycles.

### Multi Enzyme Composition

The term “multi enzyme composition” is intended to mean a composition comprising two or more enzymes having a detergency benefit.

Preferably, the multi enzyme composition comprises two or more enzymes selected among protease, amylase, such as alpha-amylase, lipase, cellulase, cutinase, acyltransferase, endoglucanase, xyloglucanase, mannanase, arabinase, galactanase, pectinase, pectate lyase, xanthanase, xanthan lyase, xylanase, chlorophylase, oxidase such as laccase and/or peroxidase.

The multi enzyme composition comprises two or more enzymes, such as three or more enzymes, such as four or more enzymes, such as five or more enzymes, such as six or more enzymes such as seven or more enzymes.

The two or more enzymes may belong to the same class of enzymes or they may belong to different classes of enzymes, where the latter is preferred.

In one embodiment, the multi enzyme composition comprises two or more enzymes and comprises a protease and an amylase, a protease and a cellulase, a protease and a lipase, a protease and a pectinase, a protease and a mannanase, a protease and a xyloglucanase, a protease and a xanthanase, an amylase and a cellulase, an amylase and a lipase, an amylase and a pectinase, an amylase and a mannanase, an amylase and a xyloglucanase, an amylase and a xanthanase, a cellulose and a lipase, a cellulase and a pectinase, a cellulase and a mannanase, a cellulase and a xyloglucanase, a cellulase and a xanthanase, a lipase and a pectinase, a lipase and a mannanase, a lipase and a xyloglucanase, a lipase and a xanthanase, a pectinase and a mannanase, a pectinase and a xyloglucanase, a pectinase and a xanthanase, a mannanase and a xyloglucanase, a mannanase and a xanthanase or a xyloglucanase and a xanthanase.

In another embodiment, the multi enzyme composition comprises three or more enzymes and comprises a protease, an amylase and a cellulase; a protease, an amylase and a lipase; a protease, an amylase and a pectinase; a protease, an amylase and a mannanase; a protease, an amylase and a xyloglucanase; a protease, an amylase and a xanthanase; a protease, a callulase and a lipase; a protease, a cellulase and a pectinase; a protease, a cellulase and a mannanase; a protease, a cellulase and a xyloglucanase; a protease a cellulase and a xanthanase; a protease, a lipase and a pectinase; a protease, a lipase and a mannanase; a protease a lipase and a xyloglucanase; a protease, a lipase and a xanthanase; a protease, a pectinase and a mannanase; a protease, a pectinase and a xyloglucanase; a protease, a pectinase and a xanthanase; a protease, a mannanase and a xyloglucanase; a protease, a mannanase and a xanthanase; a protease, a xyloglucanase and a xanthanase.

In a preferred embodiment, the multi enzyme composition comprises a protease, an amylase and a cellulase, more preferred the multi enzyme composition comprises a protease, an amylase, a cellulase and a lipase, more preferred the multi enzyme composition comprises a protease, an amylase, a cellulase, a lipase and a pectinase; even more preferred the multi enzyme composition comprises a protease, an amylase, a cellulase, a lipase and a further enzyme selected among xyloglucanase, mannanase, xanthanase, peroxidise, laccase and oxidase.

In a preferred embodiment, the multi enzyme composition comprises one or more polypeptides selected among:
i) Alkaline proteases having at least 90% identity to the amino acid sequence of subtilisin 309 as disclosed in EP 396608 or variants described in WO 92/19729, WO 98/20115, WO 98/20116, and WO 98/34946, especially the variants with substitutions in one or more of the following positions: 27, 36, 57, 76, 87, 97, 101, 104, 120, 123, 167, 170, 194, 206, 218, 222, 224, 235, and 274;
ii) Amylases or variants described in WO 94/02597, WO 94/18314, WO 96/23873, and WO 97/43424, especially the variants with substitutions in one or more of the following positions: 15, 23, 105, 106, 124, 128, 133, 154, 156, 181, 188, 190, 197, 202, 208, 209, 243, 264, 304, 305, 391, 408, and 444; or alpha-amylase having SEQ ID NO: 12 in WO 01/66712 or a variant having at least 80% sequence identity to SEQ ID NO: 12 and having a substitution, a deletion or an insertion of one amino acids downstream for the amino acid corresponding to the positions in the amylase having SEQ ID NO: 12 in WO 01/66712: R28, R118, N174; R181, G182, D183, G184, G186, W189, N195, M202, Y298, N299, K302, S303, N306, R310, N314; R320, H324, E345, Y396, R400, W439, R444, N445, K446, Q449, R458, N471, N484. Particular preferred amylases include such an variant having a deletion of D183 and G184 and having the substitutions R118K, N195F, R320K and R458K and a variant additionally having substitutions in one or more position selected from the group: M9, G149, G182, G186, M202, T257, Y295, N299, M323, A339 and E345, most preferred a variant that additionally having substitutions in all these positions; or variant alpha-amylase derived from a parent α-amylase derived from B. licheniformis comprising the mutation: A1*+N2*+L3V+M15T+R23K+S29A+A30E+Y31H+A33S+E34D+H35I+M197T;
iii) cellulases having a sequence of at least 97% identity to the amino acid sequence of position 1 to position 773 of SEQ ID NO:2 in WO 02/099091, or a variant thereof having substitution, insertion and/or deletion at one or more of the positions corresponding to the following positions in SEQ ID NO: 8 of WO 02/099091: 2, 4, 7, 8, 10, 13, 15, 19, 20, 21, 25, 26, 29, 32, 33, 34, 35, 37, 40, 42, 42a, 43, 44, 48, 53, 54, 55, 58, 59, 63, 64, 65, 66, 67, 70, 72, 76, 79, 80, 82, 84, 86, 88, 90, 91, 93, 95, 95d, 95h, 95j, 97, 100, 101, 102, 103, 113, 114, 117, 119, 121, 133, 136, 137, 138, 139, 140a, 141, 143a, 145, 146, 147, 150e, 150j, 151, 152, 153, 154, 155, 156, 157, 158, 159, 160c, 160e, 160k, 161, 162, 164, 165, 168, 170, 171, 172, 173, 175, 176, 178, 181, 183, 184, 185, 186, 188, 191, 192, 195, 196, 200, and/or 20, preferably selected among P19A, G20K, Q44K, N48E, Q119H or Q146 R; or an endoglucanase which is immunoreactive with an antibody raised against a highly purified ˜43 kD endoglucanase derived from Humicola insolens, DSM 1800, or which is homologous to said ˜43 kD endoglucanase
iv) lipase from Thermomyces, e.g., from T. lanuginosus (previously named Humicola lanuginosa) as described in EP 258 068 and EP 305 216, cutinase from Humicola, e.g. H. insolens as described in WO 96/13580, a Pseudomonas lipase, e.g., from P. alcaligenes or P. pseudoalcaligenes (EP 218 272), P. cepacia (EP 331 376), P. stutzeri (GB 1,372,034), P. fluorescens, Pseudomonas sp. strain SD 705 (WO 95/06720 and WO 96/27002), P. wisconsinensis (WO 96/12012), a Bacillus lipase, e.g., from B. subtilis (Dartois et al., 1993, Biochemica et Biophysica Acta, 1131: 253-360), B. stearothermophilus (JP 64/744992) or B. pumilus (WO 91/16422); or lipase variants such as those described in WO 92/05249, WO 94/01541, EP 407 225, EP 260 105, WO 95/35381, WO 96/00292, WO 95/30744, WO 94/25578, WO 95/14783, WO 95/22615, WO 97/04079, WO 97/07202, WO 00/060063, WO2007/087508 and WO 2009/109500;
v) xyloglucanases having at least 80% sequence identity to SEQ ID NO: 3 or WO 2009/147210, or a variant having a substitution, deletion or insertion in one or more of the positions 68, 123, 156, 118, 200, 129, 137, 193, 92, 83, 149, 34, 340, 332, 9, 76, 331, 310, 324, 498, 395, 366, 1, 374, 7, 140, 8, 14, 21, 211, 37, 45, 13, 78, 87, 436, 101, 104, 111, 306, 117, 119, 414, 139, 268, 142, 159, 164, 102, 168, 176, 180, 482, 183, 202, 206, 217, 4, 222, 19, 224, 228, 232, 2, 240, 244, 5, 247, 249, 328, 252, 259, 406, 267, 269, 275, 179, 166, 278, 281, 288, 298, 301, 18, 302, 165, 80, 303, 316, 169, 322, 120, 146, 342, 348, 147, 353, 380, 468, 382, 383, 38, 384, 389, 391, 10, 392, 396, 177, 397, 399, 409, 237, 413, 253, 415, 418, 40, 443, 445, 148, 449, 225, 450, 454, 3, 455, 456, 299, 461, 470, 204, 476, 488, 347, and 507, which position corresponds to a position in amino acid sequence SEQ ID NO:3 of WO 2009/147210, preferably selected among Q68H,N,L; S123P,T; R156Y,F,V,I,K,W,L,M; K118A,R; G200P,E,S,D; K129T,A,S; Q137E; H193T,S,D; T92V,I,A,S; A83E; Q149E; L34F,I,V; R340T,N; S332P; T9D; S76W,V,I,K,R,T; N331F,C; M310I,V,L; D324N; G498A,D; D395G and D366H.

vi) pectate lyases having at least 65% sequence identity to SEQ ID NO: 2 of WO 2003/095638 or a variant thereof having an alteration, such as a substitution, an insertion of an amino acids downstream of the position indicated or a deletion of the amino acid that occupies the position, at one or more positions selected from the group consisting of positions number: 5, 9, 11, 26, 28, 30, 31, 37, 40, 45, 46, 47, 48, 49, 50, 51, 52, 54, 61, 64, 68, 69, 70, 71, 74, 75, 76, 79, 86, 87, 91, 99, 105, 106, 107, 111, 115, 116, 118, 122, 123, 134, 136, 139, 140, 141, 146, 148, 156, 158, 170, 182, 185, 186, 189, 193, 194, 196, 199, 201, 202, 204, 213, 215, 218, 224, 228, 229, 234, 235, 237, 251, 256, 257, 258, 272, 277, 286, 295, 298, 301, 302, 303, 305, 307, 308, 314, 316, 323, 324, 326, 331, 332, 333, 334, 335, 336, 337, 338, 339, 340, 341, 349, 356, 357, 363, 366, 378, 381, 384, 386, 387, 389, 390, 391, 393 and 397; or
vii) mannanases having a sequence that is at least 65% identiocal to SEQ ID NO: 2 of WO 99/64619.

In a preferred embodiment, the multi enzyme composition comprises one or more polypeptides selected among:
i) Alkaline proteases having at least 90% identity to the amino acid sequence of SEQ ID NO: 1 or a variant thereof with substitutions in one or more of the following positions: 27, 36, 57, 76, 87, 97, 101, 104, 120, 123, 167, 170, 194, 206, 218, 222, 224, 235, and 274, preferably the variant is an alkaline protease having at least 90% identity to the amino acid sequence of SEQ ID NO: 1 with the following substitution: M222S;
ii) Amylases or variants thereof selected from the group consisting of:
   a. An α-amylase variant, wherein the α-amylase have been modified so that one or more of the methionine amino acid residues is exchanged with any amino acid residue except for Cys and Met, preferably so that the methionine amino acid residue in position 197 in B. licheniformis α-amylase or the methionine amino acid residue in homologous positions in other α-amylases is modified to Thr. and;
   b. an alpha-amylase having SEQ ID NO: 2 or a variant thereof having at least 80% sequence identity to SEQ ID NO: 2 and having a substitution, a deletion or an insertion of one amino acids downstream for the amino acid corresponding to the positions in the amylase having SEQ ID NO: 2: R28, R118, N174; R181, G182, D183, G184, G186, W189, N195, M202, Y298, N299, K302, S303, N306, R310, N314; R320, H324, E345, Y396, R400, W439, R444, N445, K446, Q449, R458, N471, N484; Particular preferred amylases include such a variant having a deletion of D183 and G184 and having the substitutions R118K, N195F, R320K and R458K and a variant additionally having substitutions in one or more positions selected from the group: M9, G149, G182, G186, M202, T257, Y295, N299, M323, A339 and E345, most preferred a variant additionally having substitutions in all these positions; or a variant alpha-amylase derived from a parent α-amylase derived from B. licheniformis comprising the mutation: A1*+N2*+L3V+M15T+R23K+S29A+A30E+Y31H+A33S+E34D+H35I+M197T
iii) cellulases selected from the group consisting of:
   a. cellulases having a sequence of at least 97% identity to the amino acid sequence of position 1 to position 773 of SEQ ID NO:3, or a variant thereof having substitution, insertion and/or deletion at one or more of the positions corresponding to the following positions in SEQ ID NO: 3: 2, 4, 7, 8, 10, 13, 15, 19, 20, 21, 25, 26, 29, 32, 33, 34, 35, 37, 40, 42, 42a, 43, 44, 48, 53, 54, 55, 58, 59, 63, 64, 65, 66, 67, 70, 72, 76, 79, 80, 82, 84, 86, 88, 90, 91, 93, 95, 95d, 95h, 95j, 97, 100, 101, 102, 103, 113, 114, 117, 119, 121, 133, 136, 137, 138, 139, 140a, 141, 143a, 145, 146, 147, 150e, 150j, 151, 152, 153, 154, 155, 156, 157, 158, 159, 160c, 160e, 160k, 161, 162, 164, 165, 168, 170, 171, 172, 173, 175, 176, 178, 181, 183, 184, 185, 186, 188, 191, 192, 195, 196, 200, and/or 20, preferably selected among P19A, G20K, Q44K, N48E, Q119H or Q146 R; and
iv) cellulases derived from Humicola insolens, Myceliophthora thermophila, Sporotrichum pulverulentum, Fusarium oxysporum, Trichoderma reesei, Thielavia terrestris, Acremonium sp., Acremonium sp. CBS 478.94, Macrophomina phaseolina CBS 281.96, Crinipellis scabella CBS 280.96, Volutella colletotrichoides or Sordaria fimicola ATCC 52644 or Bacillus SP-KSMS237. lipase selected from the group consisting of:
   a. the lipase is derived from Thermomyces, e.g., from T. lanuginosus, cutinase from Humicola, e.g. H. insolens, a Pseudomonas lipase, e.g., from P. alcaligenes or P. pseudoalcaligenes, P. cepacia, P. sp. strain SD705, P. stutzeri, P. fluorescens, Pseudomonas sp. strain SD 705, P. wisconsinensis, GDSL-type Streptomyces lipases, cutinase from Magnaporthe grisea, cutinase from Pseudomonas mendocina, Thermobifida fusca, Geobacillus stearothermophilus, Streptomyces griseus, S. pristinaespiralis a Bacillus lipase, e.g., from B. subtilis, B. stearothermophilus or B. pumilus; and
   b. wherein the lipase is a polypeptide having an amino acid sequence which:
      a) has at least 90% identity with the wild-type lipase derived from Humicola lanuginosa strain DSM 4109;
      b) compared to said wild-type lipase, comprises a substitution of an electrically neutral or negatively charged amino acid at the surface of the three-dimensional structure within 15 Å of E1 or Q249 with a positively charged amino acid; and
      c) comprises a peptide addition at the C-terminal; and/or
      d) meets the following limitations:
      i. comprises a negative amino acid in position E210 of said wild-type lipase;
      ii. comprises a negatively charged amino acid in the region corresponding to positions 90-101 of said wild-type lipase; and
      iii. comprises a neutral or negative amino acid at a position corresponding to N94 of said wild-type lipase and/or has a negative or neutral net electric charge in the region corresponding to positions 90-101 of said wild-type lipase.
v) xyloglucanases having at least 80% sequence identity to SEQ ID NO: 4, or a variant having a substitution, deletion or insertion in one or more of the positions 68, 123, 156, 118, 200, 129, 137, 193, 92, 83, 149, 34, 340, 332, 9, 76, 331, 310, 324, 498, 395, 366, 1, 374, 7, 140, 8, 14, 21, 211, 37, 45, 13, 78, 87, 436, 101, 104, 111, 306, 117, 119, 414, 139, 268, 142, 159, 164, 102, 168, 176, 180, 482, 183, 202, 206, 217, 4, 222, 19, 224, 228, 232, 2, 240, 244, 5, 247, 249, 328, 252, 259, 406, 267, 269, 275, 179, 166, 278, 281, 288, 298, 301, 18, 302, 165, 80, 303, 316, 169, 322, 120, 146, 342, 348, 147, 353, 380, 468, 382, 383, 38, 384, 389, 391, 10, 392, 396, 177, 397, 399, 409, 237, 413, 253, 415, 418, 40, 443, 445, 148, 449, 225, 450, 454, 3, 455, 456, 299, 461, 470, 204, 476, 488, 347, and 507, which position corresponds to a position in amino acid sequence SEQ ID NO:4, preferably selected among Q68H,N,L; S123P,T; R156Y,F,V,I,K,W,L,M; K118A,R; G200P,E,S,D; K129T,A,S; Q137E; H193T,S,D; T92V,I,A,S; A83E; Q149E; L34F,I,V; R340T,N; S332P; T9D; S76W,V,I,K,R,T; N331F,C; M310I,V,L; D324N; G498A,D; D395G and D366H;
vi) pectate lyases having at least 65% sequence identity to SEQ ID NO: 5 or a variant thereof having an alteration, such as a substitution, an insertion of an amino acids downstream of the position indicated or a deletion of the amino acid that occupies the position, at one or more positions selected from the group consisting of positions number: 5, 9, 11, 26, 28, 30, 31, 37, 40, 45, 46, 47, 48, 49, 50, 51, 52, 54, 61, 64, 68, 69, 70, 71, 74, 75, 76, 79, 86, 87, 91, 99, 105, 106, 107, 111, 115, 116, 118, 122, 123, 134, 136, 139, 140, 141, 146, 148, 156, 158, 170, 182, 185, 186, 189, 193, 194, 196, 199, 201, 202, 204, 213, 215, 218, 224, 228, 229, 234, 235, 237, 251, 256, 257, 258, 272, 277, 286, 295, 298, 301, 302, 303, 305, 307, 308, 314, 316, 323, 324, 326, 331, 332, 333, 334, 335, 336, 337, 338, 339, 340, 341, 349, 356, 357, 363, 366, 378, 381, 384, 386, 387, 389, 390, 391, 393 and 397; or
vii) mannanases having a sequence that is at least 65% identical to SEQ ID NO: 6.

In another preferred embodiment, the multi enzyme composition comprises five or more enzymes selected among a protease, an amylase, a lipase, a pectate lyase and a cellulase. Preferably the multi enzyme composition comprises following enzymes:
1) A protease comprising an amino acid sequence at least 90% identical to the amino acid sequence of subtilisin 309 as disclosed in EP 396608, wherein the methionine in position 222 is substituted with another amino acid residue;
2) A variant alpha-amylase derived from a parent α-amylase derived from B. licheniformis comprising the mutation: A1*+N2*+L3V+M15T+R23K+S29A+A30E+Y31H+A33S+E34D+H35I+M197T;
3) A variant alpha-amylase derived from a parent alpha-amylase having the sequence SEQ ID NO: 12 in WO01/66712, the variant having a deletion of D183 and G184 and having the substitutions R118K, N195F, R320K and R458K and a variant additionally having substitutions in one or more position selected from the group: M9, G149, G182, G186, M202, T257, Y295, N299, M323, A339 and E345, most preferred a variant that additionally having substitutions in all these positions;
4) A lipase having at least 90% identity with the wild-type lipase derived from Humicola lanuginosa strain DSM 4109 and comprising the substitutions T231R and N233R;
5) A pectate lyase having at least 65% sequence identity to SEQ ID NO: 2 of WO 2003/095638 or a variant thereof having an alteration, such as a substitution, an insertion of an amino acids downstream of the position indicated or a deletion of the amino acid that occupies the position, at one or more positions selected from the group consisting of positions number: 5, 9, 11, 26, 28, 30, 31, 37, 40, 45, 46, 47, 48, 49, 50, 51, 52, 54, 61, 64, 68, 69, 70, 71, 74, 75, 76, 79, 86, 87, 91, 99, 105, 106, 107, 111, 115, 116, 118, 122, 123, 134, 136, 139, 140, 141, 146, 148, 156, 158, 170, 182, 185, 186, 189, 193, 194, 196, 199, 201, 202, 204, 213, 215, 218, 224, 228, 229, 234, 235, 237, 251, 256, 257, 258, 272, 277, 286, 295, 298, 301, 302, 303, 305, 307, 308, 314, 316, 323, 324, 326, 331, 332, 333, 334, 335, 336, 337, 338, 339, 340, 341, 349, 356, 357, 363, 366, 378, 381, 384, 386, 387, 389, 390, 391, 393 and 397
6) A cellulase having a sequence of at least 97% identity to the amino acid sequence of position 1 to position 773 of SEQ ID NO:2 in WO02/099091, or a variant thereof substitution at one or more of the positions selected among P19A, G20K, Q44K, N48E, Q119H or Q146 R.

Most preferred the multi enzyme composition comprises one enzyme from each of the enzymes 1-6 described above.

In another preferred embodiment, the multi enzyme composition comprises five or more enzymes selected among a protease, an amylase, a lipase, a pectate lyase and a cellulase. Preferably the multi enzyme composition comprises following enzymes:
i) A protease comprising an amino acid sequence at least 90% identical to the amino acid sequence of of SEQ ID NO: 1, wherein the methionine in position 222 is substituted with another amino acid residue;
ii) A variant alpha-amylase derived from a parent α-amylase derived from B. licheniformis comprising the mutation: A1*+N2*+L3V+M15T+R23K+S29A+A30E+Y31H+A33S+E34D+H35I+M197T;
iii) A variant alpha-amylase derived from a parent alpha-amylase having the sequence SEQ ID NO: 2, the variant having a deletion of D183 and G184 and having the substitutions R118K, N195F, R320K and R458K and a variant additionally having substitutions in one or more positions selected from the group: M9, G149, G182, G186, M202, T257, Y295, N299, M323, A339 and E345, most preferred a variant that additionally having substitutions in all these positions;
iv) A lipase having at least 90% identity with the wild-type lipase derived from Humicola lanuginosa strain DSM 4109 and comprising the substitutions T231R and N233R;
v) A pectate lyase having at least 65% sequence identity to SEQ ID NO: 5 or a variant thereof having an alteration, such as a substitution, an insertion of an amino acids downstream of the position indicated or a deletion of the amino acid that occupies the position, at one or more positions selected from the group consisting of positions number: 5, 9, 11, 26, 28, 30, 31, 37, 40, 45, 46, 47, 48, 49, 50, 51, 52, 54, 61, 64, 68, 69, 70, 71, 74, 75, 76, 79, 86, 87, 91, 99, 105, 106, 107, 111, 115, 116, 118, 122, 123, 134, 136, 139, 140, 141, 146, 148, 156, 158, 170, 182, 185, 186, 189, 193, 194, 196, 199, 201, 202, 204, 213, 215, 218, 224, 228, 229, 234, 235, 237, 251, 256, 257, 258, 272, 277, 286, 295, 298, 301, 302, 303, 305, 307, 308, 314, 316, 323, 324, 326, 331, 332, 333, 334, 335, 336, 337, 338, 339, 340, 341, 349, 356, 357, 363, 366, 378, 381, 384, 386, 387, 389, 390, 391, 393 and 397;
vi) A cellulase having a sequence of at least 97% identity to the amino acid sequence of position 1 to position 773 of SEQ ID NO:3, or a variant thereof substitution at one or more of the positions selected among P19A, G20K, Q44K, N48E, Q119H or Q146 R, or a cellulase derived from Humicola insolens.

Most preferred the multi enzyme composition comprises one enzyme from each of the enzymes i) to vi) described above.

For use in the method of the invention, the enzymes in the multi enzyme composition is added in amounts sufficient to achieve the desired cleaning benefit in the final solution. The multi enzyme composition may be concentrated and consequently a small amount of the composition is needed in order to achieve the desired concentration of the enzymes in the final wash liquor, or the multi enzyme composition may be less concentration in which case a larger amount of the composition must be added to the wash liquor. It is within the capabilities of the average practitioner to select a suitable dosing of a given multi enzyme composition based on the concentration of the individual enzymes therein.

In one embodiment of the present invention, the multi enzyme composition is added in an amount so each enzyme is present in the wash liquor in an amount corresponding to 0.001-200 mg of protein, such as 0.005-100 mg of protein, preferably 0.01-50 mg of protein, more preferably 0.05-20 mg of protein, even more preferably 0.1-10 mg of protein per liter of wash liquor.

Even though the multi enzyme composition is described herein as a single composition, it is also contemplated that in the method of the invention, the enzymes of the multi enzyme composition may be provided in form of two or more composition that is combined in the detergent solution before laundering begins. Further, it is contemplated that the detergent composition and the multi enzyme composition may be provided as one composition that is applied to the detergent solution before laundering begins or it may be provided in two or more compositions that is combined in the solution. The skilled person will appreciate the form the detergent composition and the multi enzyme composition is provided in is not decisive for the invention but what is important is that the detergent ingredients and the enzymes are present in the solution before laundering begins.

In general, the properties of the selected enzyme(s) should be compatible with the selected detergent, (i.e., pH-optimum, compatibility with other enzymatic and non-enzymatic ingredients, etc.), and the enzyme(s) should be present in effective amounts.

Cellulases: Suitable cellulases include those of bacterial or fungal origin. Chemically modified or protein engineered mutants are included. Suitable cellulases include cellulases from the genera Bacillus, Pseudomonas, Humicola, Fusarium, Thielavia, Acremonium, e.g., the fungal cellulases produced from Humicola insolens, Myceliophthora thermophila and Fusarium oxysporum disclosed in U.S. Pat. No. 4,435,307, U.S. Pat. No. 5,648,263, U.S. Pat. No. 5,691,178, U.S. Pat. No. 5,776,757 and WO 89/09259.

Especially suitable cellulases are the alkaline or neutral cellulases having colour care benefits. Examples of such cellulases are cellulases described in EP 0 495 257, EP 0 531 372, WO 96/11262, WO 96/29397, WO 98/08940. Other examples are cellulase variants such as those described in WO 94/07998, EP 0 531 315, U.S. Pat. No. 5,457,046, U.S. Pat. No. 5,686,593, U.S. Pat. No. 5,763,254, WO 95/24471, WO 98/12307 and PCT/DK98/00299.

Commercially available cellulases include Celluclean™, and Carezyme™ (Novozymes A/S), Clazinase™, and Puradax HA™ (Genencor International Inc.), and KAC-500(B)™ (Kao Corporation).

As example of preferred cellulases can be mentioned an enzyme exhibiting endo-beta-1,4-glucanase activity (EC 3.2.1.4), having a sequence of at least 97% identity to the amino acid sequence of position 1 to position 773 of SEQ ID NO:2 in WO02/099091.

Other examples of preferred cellulases include the family 45 cellulases having at least 70% sequence identity to SEQ ID NO: 8 of WO96/29397, or a variant thereof having substitution, insertion and/or deletion at one or more of the positions corresponding to the following positions in SEQ ID NO: 8 of WO 02/099091: 2, 4, 7, 8, 10, 13, 15, 19, 20, 21, 25, 26, 29, 32, 33, 34, 35, 37, 40, 42, 42a, 43, 44, 48, 53, 54, 55, 58, 59, 63, 64, 65, 66, 67, 70, 72, 76, 79, 80, 82, 84, 86, 88, 90, 91, 93, 95, 95d, 95h, 95j, 97, 100, 101, 102, 103, 113, 114, 117, 119, 121, 133, 136, 137, 138, 139, 140a, 141, 143a, 145, 146, 147, 150e, 150j, 151, 152, 153, 154, 155, 156, 157, 158, 159, 160c, 160e, 160k, 161, 162, 164, 165, 168, 170, 171, 172, 173, 175, 176, 178, 181, 183, 184, 185, 186, 188, 191, 192, 195, 196, 200, and/or 20, preferably selected among P19A, G20K, Q44K, N48E, Q119H or Q146 R.

Xyloglucanases: Suitable xyloglucanases include those of bacterial origin. Chemically modified or protein engineered mutants are included. Suitable xyloglucanases include xyloglucanases from the genera Bacillus, Pseudomonas and Paenibacillus e.g., the bacterial xyloglucanase produced from Paenibacillus polymyxa disclosed in WO2001/062903.

Especially suitable xyloglucanases are the alkaline or neutral xyloglucanases having whiteness benefits. Examples of such xyloglucanases are described in WO2001/062903. Other examples are xyloglucanase variants such as those described in WO2009/147210.

Commercially available xyloglucanases include Whitezyme™ (Novozymes A/S).

Other examples of suitable xyloglucanases are xyloglucanases having at least 80% sequence identity to SEQ ID NO: 3 or WO2009/147210, or a variant having a substitution, deletion or insertion in one or more of the positions 68, 123, 156, 118, 200, 129, 137, 193, 92, 83, 149, 34, 340, 332, 9, 76, 331, 310, 324, 498, 395, 366, 1, 374, 7, 140, 8, 14, 21, 211, 37, 45, 13, 78, 87, 436, 101, 104, 111, 306, 117, 119, 414, 139, 268, 142, 159, 164, 102, 168, 176, 180, 482, 183, 202, 206, 217, 4, 222, 19, 224, 228, 232, 2, 240, 244, 5, 247, 249, 328, 252, 259, 406, 267, 269, 275, 179, 166, 278, 281, 288, 298, 301, 18, 302, 165, 80, 303, 316, 169, 322, 120, 146, 342, 348, 147, 353, 380, 468, 382, 383, 38, 384, 389, 391, 10, 392, 396, 177, 397, 399, 409, 237, 413, 253, 415, 418, 40, 443, 445, 148, 449, 225, 450, 454, 3, 455, 456, 299, 461, 470, 204, 476, 488, 347, and 507, which position corresponds to a position in amino acid sequence SEQ ID NO:3 of WO2009/147210, preferably selected among Q68H,N,L; S123P,T; R156Y,F,V,I,K,W,L,M; K118A,R; G200P,E,S,D; K129T,A,S; Q137E; H193T,S,D; T92V,I,A,S; A83E; Q149E; L34F,I,V; R340T,N; S332P; T9D; S76W,V,I,K,R,T; N331F,C; M310I,V,L; D324N; G498A,D; D395G and D366H.

Pectate lyases: Suitable pectate lyases include those of bacterial origin. Chemically or modified or protein engineered mutants are included. Suitable pectate lyases include pectate lyases from the genus Bacillus e.g., the bacterial pectate lyase produced from Bacillus licheniformis disclosed in WO99/27083, or the bacterial pectate lyase produced from Bacillus subtilis disclosed in WO02/092741.

Other suitable pectate lyases include pectate lyases having at least 65% sequence identity to SEQ ID NO: 2 of WO2003/095638 or a variant thereof having an alteration, such as a substitution, an insertion of an amino acids downstream of the position indicated or a deletion of the amino acid that occupies the position, at one or more positions selected from the group consisting of positions number: 5, 9, 11, 26, 28, 30, 31, 37, 40, 45, 46, 47, 48, 49, 50, 51, 52, 54, 61, 64, 68, 69, 70, 71, 74, 75, 76, 79, 86, 87, 91, 99, 105, 106, 107, 111, 115, 116, 118, 122, 123, 134, 136, 139, 140, 141, 146, 148, 156, 158, 170, 182, 185, 186, 189, 193, 194, 196, 199, 201, 202, 204, 213, 215, 218, 224, 228, 229, 234, 235, 237, 251, 256, 257, 258, 272, 277, 286, 295, 298, 301, 302, 303, 305, 307, 308, 314, 316, 323, 324, 326, 331, 332, 333, 334, 335, 336, 337, 338, 339, 340, 341, 349, 356, 357, 363, 366, 378, 381, 384, 386, 387, 389, 390, 391, 393 and 397.

Commercially available pectate lyases include Xpect™ (Novozymes A/S).

Mannanases: Suitable mannanases include those of bacterial origin. Chemically or modified or protein engineered mutants are included. Suitable mannanases include mannanases from the genus Bacillus e.g., the bacterial Mannanase produced from Bacillus licheniformis disclosed in WO99/64619.

Other suitable mannanases are mannanases having a sequence that is at least 65% identiocal to SEQ ID NO: 2 of WO 99/64619.

Commercially available mannanases include Mannaway™ (Novozymes A/S)

Proteases: Suitable proteases include those of animal, vegetable or microbial origin. Microbial origin is preferred. Chemically modified or protein engineered mutants are included. The protease may be a serine protease or a metalloprotease, preferably an alkaline microbial protease or a trypsin-like protease. Examples of alkaline proteases are subtilisins, especially those derived from Bacillus, e.g., subtilisin Novo, subtilisin Carlsberg, subtilisin 309, subtilisin 147 and subtilisin 168 (described in WO 89/06279). Examples of trypsin-like proteases are trypsin (e.g., of porcine or bovine origin) and the Fusarium protease described in WO 89/06270 and WO 94/25583.

Examples of useful proteases are the variants described in WO 92/19729, WO 98/20115, WO 98/20116, and WO 98/34946, especially the variants with substitutions in one or more of the following positions: 27, 36, 57, 76, 87, 97, 101, 104, 120, 123, 167, 170, 194, 206, 218, 222, 224, 235, and 274.

Preferred commercially available protease enzymes include Alcalase™, Savinase™, Primase™, Duralase™, Esperase™, and Kannase™ (Novozymes A/S), Maxatase™, Maxacal™, Maxapem™, Properase™, Purafect™, Purafect OxP™, FN2™, and FN3™ (Genencor International Inc.).

Lipases and Cutinases: Suitable lipases and cutinases include those of bacterial or fungal origin. Chemically modified or protein engineered mutants are included. Examples include lipase from Thermomyces, e.g., from T. lanuginosus (previously named Humicola lanuginosa) as described in EP 258 068 and EP 305 216, cutinase from Humicola, e.g. H. insolens as described in WO 96/13580, a Pseudomonas lipase, e.g., from P. alcaligenes or P. pseudoalcaligenes (EP 218 272), P. cepacia (EP 331 376), P. stutzeri (GB 1,372,034), P. fluorescens, Pseudomonas sp. strain SD 705 (WO 95/06720 and WO 96/27002), P. wisconsinensis (WO 96/12012), a Bacillus lipase, e.g., from B. subtilis (Dartois et al., 1993, Biochemica et Biophysica Acta, 1131: 253-360), B. stearothermophilus (JP 64/744992) or B. pumilus (WO 91/16422).

Other examples are lipase variants such as those described in WO 92/05249, WO 94/01541, EP 407 225, EP 260 105, WO 95/35381, WO 96/00292, WO 95/30744, WO 94/25578, WO 95/14783, WO 95/22615, WO 97/04079, WO 97/07202, WO 00/060063, WO2007/087508 and WO 2009/109500.

Preferred commercially available lipase enzymes include Lipolase™, Lipolase Ultra™, and Lipex™; Lecitase™, Lipolex™; Lipoclean™, Lipoprime™ (Novozymes A/S). Other commercially available lipases include Lumafast (Genencor Int Inc); Lipomax (Gist-Brocades/Genencor Int Inc) and Bacillus sp lipase from Solvay.

Amylases: Suitable amylases (α and/or β) include those of bacterial or fungal origin.

Chemically modified or protein engineered mutants are included. Amylases include, for example, α-amylases obtained from Bacillus, e.g., a special strain of Bacillus licheniformis, described in more detail in GB 1,296,839.

Examples of useful amylases are the variants described in WO 94/02597, WO 94/18314, WO 96/23873, and WO 97/43424, especially the variants with substitutions in one or more of the following positions: 15, 23, 105, 106, 124, 128, 133, 154, 156, 181, 188, 190, 197, 202, 208, 209, 243, 264, 304, 305, 391, 408, and 444.

Other useful amylases are the alpha-amylase having SEQ ID NO: 12 in WO 01/66712 or a variant having at least 80% sequence identity to SEQ ID NO: 12 and having a substitution, a deletion or an insertion of one amino acids downstream for the amino acid corresponding to the positions in the amylase having SEQ ID NO: 12 in WO01/66712: R28, R118, N174; R181, G182, D183, G184, G186, W189, N195, M202, Y298, N299, K302, S303, N306, R310, N314; R320, H324, E345, Y396, R400, W439, R444, N445, K446, Q449, R458, N471, N484. Particular preferred amylases include such an variant having a deletion of D183 and G184 and having the substitutions R118K, N195F, R320K and R458K and a variant additionally having substitutions in one or more position selected from the group: M9, G149, G182, G186, M202, T257, Y295, N299, M323, A339 and E345, most preferred a variant that additionally having substitutions in all these positions.

A further useful alpha-amylase according to the invention is a variant alpha-amylase derived from a parent α-amylase derived from B. licheniformis comprising the mutation: A1*+N2*+L3V+M15T+R23K+S29A+A30E+Y31H+A33S+E34D+H35I+M197T

Commercially available amylases are Duramyl™, Termamyl™, Fungamyl™, Stainzyme™, Stainzyme™ Plus, Natalase™ and BAN™ (Novozymes A/S), Rapidase™ and Purastar™ (from Genencor International Inc.).

Peroxidases/Oxidases: Suitable peroxidases/oxidases include those of plant, bacterial or fungal origin. Chemically modified or protein engineered mutants are included. Examples of useful peroxidases include peroxidases from Coprinus, e.g., from C. cinereus, and variants thereof as those described in WO 93/24618, WO 95/10602, and WO 98/15257.

Commercially available peroxidases include Guardzyme™ (Novozymes A/S).

The detergent enzyme(s) may be included in a detergent composition by adding separate additives containing one or more enzymes, or by adding a combined additive comprising all of these enzymes. A detergent additive of the invention, i.e., a separate additive or a combined additive, can be formulated, for example, as a granulate, liquid, slurry, etc. Preferred detergent additive formulations are granulates, in particular non-dusting granulates, liquids, in particular stabilized liquids, or slurries.

Non-dusting granulates may be produced, e.g. as disclosed in U.S. Pat. Nos. 4,106,991 and 4,661,452 and may optionally be coated by methods known in the art. Examples of waxy coating materials are poly(ethylene oxide) products (polyethyleneglycol, PEG) with mean molar weights of 1000 to 20000; ethoxylated nonylphenols having from 16 to 50 ethylene oxide units; ethoxylated fatty alcohols in which the alcohol contains from 12 to 20 carbon atoms and in which there are 15 to 80 ethylene oxide units; fatty alcohols; fatty acids; and mono- and di- and triglycerides of fatty acids. Examples of film-forming coating materials suitable for application by fluid bed techniques are given in GB 1483591. Liquid enzyme preparations may, for instance, be stabilized by adding a polyol such as propylene glycol, a sugar or sugar alcohol, lactic acid or boric acid according to established methods. Protected enzymes may be prepared according to the method disclosed in EP 238,216.

The enzyme(s) of the detergent composition of the invention may be stabilized using conventional stabilizing agents, e.g. a polyol such as propylene glycol or glycerol, a sugar or sugar alcohol, lactic acid, boric acid, or a boric acid derivative, e.g. an aromatic borate ester, or a phenyl boronic acid derivative such as 4-formylphenyl boronic acid, and the composition may be formulated as described in, for example, WO 92/19709 and WO 92/19708.

A polypeptide of the present invention may also be incorporated in the detergent formulations disclosed in WO 97/07202, which is hereby incorporated by reference.

### Detergent Compositions

In one embodiment, the invention is directed to detergent compositions comprising a multi enzyme composition of the present invention in combination with one or more additional cleaning composition components. The choice of additional components is within the skill of the artisan and includes conventional ingredients, including the exemplary non-limiting components set forth below.

### Surfactants

The detergent composition may comprise one or more surfactants, which may be anionic and/or cationic and/or non-ionic and/or semi-polar and/or zwitterionic, or a mixture thereof. In a particular embodiment, the detergent composition includes a mixture of one or more nonionic surfactants and one or more anionic surfactants. The surfactant(s) is typically present at a level of from about 0.1% to 60% by weight, such as about 1% to about 40%, or about 3% to about 20%, or about 3% to about 10%. The surfactant(s) is chosen based on the desired cleaning application, and includes any conventional surfactant(s) known in the art. Any surfactant known in the art for use in detergents may be utilized.

When included therein the detergent will usually contain from about 1% to about 40% by weight, such as from about 5% to about 30%, including from about 5% to about 15%, or from about 20% to about 25% of an anionic surfactant. Non-limiting examples of anionic surfactants include sulfates and sulfonates, in particular, linear alkylbenzenesulfonates (LAS), isomers of LAS, branched alkylbenzenesulfonates (BABS), phenylalkanesulfonates, alpha-olefinsulfonates (AOS), olefin sulfonates, alkene sulfonates, alkane-2,3-diylbis(sulfates), hydroxyalkanesulfonates and disulfonates, alkyl sulfates (AS) such as sodium dodecyl sulfate (SDS), fatty alcohol sulfates (FAS), primary alcohol sulfates (PAS), alcohol ethersulfates (AES or AEOS or FES, also known as alcohol ethoxysulfates or fatty alcohol ether sulfates), secondary alkanesulfonates (SAS), paraffin sulfonates (PS), ester sulfonates, sulfonated fatty acid glycerol esters, alpha-sulfo fatty acid methyl esters (alpha-SFMe or SES) including methyl ester sulfonate (MES), alkyl- or alkenylsuccinic acid, dodecenyl/tetradecenyl succinic acid (DTSA), fatty acid derivatives of amino acids, diesters and monoesters of sulfo-succinic acid or soap, and combinations thereof.

When included therein the detergent will usually contain from about _{—}0.1_% to about 40% by weight of a cationic surfactant. Non-limiting examples of cationic surfactants include alklydimethylethanolamine quat (ADMEAQ), cetyltrimethylammonium bromide (CTAB), dimethyldistearylammonium chloride (DSDMAC), and alkylbenzyldimethylammonium, alkyl quaternary ammonium compounds, alkoxylated quaternary ammonium (AQA) compounds, and combinations thereof.

When included therein the detergent will usually contain from about 0.2% to about 40% by weight of a non-ionic surfactant, for example from about 0.5% to about 30%, in particular from about 1% to about 20%, from about 3% to about 10%, such as from about 3% to about 5%, or from about 8% to about 12%. Non-limiting examples of non-ionic surfactants include alcohol ethoxylates (AE or AEO), alcohol propoxylates, propoxylated fatty alcohols (PFA), alkoxylated fatty acid alkyl esters, such as ethoxylated and/or propoxylated fatty acid alkyl esters, alkylphenol ethoxylates (APE), nonylphenol ethoxylates (NPE), alkylpolyglycosides (APG), alkoxylated amines, fatty acid monoethanolamides (FAM), fatty acid diethanolamides (FADA), ethoxylated fatty acid monoethanolamides (EFAM), propoxylated fatty acid monoethanolamides (PFAM), polyhydroxy alkyl fatty acid amides, or N-acyl N-alkyl derivatives of glucosamine (glucamides, GA, or fatty acid glucamide, FAGA), as well as products available under the trade names SPAN and TWEEN, and combinations thereof.

When included therein the detergent will usually contain from about 0.05% to about 20% by weight of a semipolar surfactant. Non-limiting examples of semipolar surfactants include amine oxides (AO) such as alkyldimethylamineoxide, N-(coco alkyl)-N,N-dimethylamine oxide and N-(tallow-alkyl)-N,N-bis(2-hydroxyethyl)amine oxide, fatty acid alkanolamides and ethoxylated fatty acid alkanolamides, and combinations thereof.

When included therein the detergent will usually contain from about 0.1% to about 20% by weight of a zwitterionic surfactant. Non-limiting examples of zwitterionic surfactants include betaine, alkyldimethylbetaine, sulfobetaine, and combinations thereof.

### Hydrotropes

A hydrotrope is a compound that solubilises hydrophobic compounds in aqueous solutions (or oppositely, polar substances in a non-polar environment). Typically, hydrotropes have both hydrophilic and a hydrophobic character (so-called amphiphilic properties as known from surfactants); however the molecular structure of hydrotropes generally do not favor spontaneous self-aggregation, see e.g. review by Hodgdon and Kaler (2007), Current Opinion in Colloid & Interface Science 12: 121-128. Hydrotropes do not display a critical concentration above which self-aggregation occurs as found for surfactants and lipids forming miceller, lamellar or other well defined meso-phases. Instead, many hydrotropes show a continuous-type aggregation process where the sizes of aggregates grow as concentration increases. However, many hydrotropes alter the phase behavior, stability, and colloidal properties of systems containing substances of polar and non-polar character, including mixtures of water, oil, surfactants, and polymers. Hydrotropes are classically used across industries from pharma, personal care, food, to technical applications. Use of hydrotropes in detergent compositions allow for example more concentrated formulations of surfactants (as in the process of compacting liquid detergents by removing water) without inducing undesired phenomena such as phase separation or high viscosity.

The detergent may contain 0-5% by weight, such as about 0.5 to about 5%, or about 3% to about 5%, of a hydrotrope. Any hydrotrope known in the art for use in detergents may be utilized. Non-limiting examples of hydrotropes include sodium benzene sulfonate, sodium p-toluene sulfonate (STS), sodium xylene sulfonate (SXS), sodium cumene sulfonate (SCS), sodium cymene sulfonate, amine oxides, alcohols and polyglycolethers, sodium hydroxynaphthoate, sodium hydroxynaphthalene sulfonate, sodium ethylhexyl sulfate, and combinations thereof.

### Builders and Co-Builders

The detergent composition may contain about 0-65% by weight, such as about 2% to about 45%, such as 5-35%, such as 10-30% of a detergent builder or co-builder, or a mixture thereof. In a dish wash detergent, the level of builder is typically 40-65%, particularly 50-65%. The builder and/or co-builder may particularly be a chelating agent that forms water-soluble complexes with Ca and Mg. Any builder and/or co-builder known in the art for use in laundry detergents may be utilized. Non-limiting examples of builders include zeolites, diphosphates (pyrophosphates), triphosphates such as sodium triphosphate (STP or STPP), carbonates such as sodium carbonate, soluble silicates such as sodium metasilicate, layered silicates (e.g., SKS-6 from Hoechst), ethanolamines such as 2-aminoethan-1-ol (MEA), diethanolamine (DEA, also known as iminodiethanol), triethanolamine (TEA, also known as 2,2′,2″-nitrilotriethanol), and carboxymethyl inulin (CMI), and combinations thereof.

The detergent composition may also contain 0-15% by weight, such as about 1% to about 5%, of a detergent co-builder, or a mixture thereof. The detergent composition may include include a co-builder alone, or in combination with a builder, for example a zeolite builder. Non-limiting examples of co-builders include homopolymers of polyacrylates or copolymers thereof, such as poly(acrylic acid) (PAA) or copoly(acrylic acid/maleic acid) (PAA/PMA). Further non-limiting examples include citrate, chelators such as aminocarboxylates, aminopolycarboxylates and phosphonates, and alkyl- or alkenylsuccinic acid. Additional specific examples include 2,2′,2″-nitrilotriacetic acid (NTA), ethylenediaminetetraacetic acid (EDTA), diethylenetriaminepentaacetic acid (DTPA), iminodisuccinic acid (IDS), ethylenediamine-N,N′-disuccinic acid (EDDS), methylglycinediacetic acid (MGDA), glutamic acid-N,N-diacetic acid (GLDA), 1-hydroxyethane-1,1-diphosphonic acid (HEDP), ethylenediaminetetra(methylenephosphonic acid) (EDTMPA), diethylenetriaminepentakis(methylenephosphonic acid) (DTMPA or DTPMPA), N-(2-hydroxyethyl)iminodiacetic acid (EDG), aspartic acid-N-monoacetic acid (ASMA), aspartic acid-N,N-diacetic acid (ASDA), aspartic acid-N-monopropionic acid (ASMP), iminodisuccinic acid (IDA), N-(2-sulfomethyl)-aspartic acid (SMAS), N-(2-sulfoethyl)-aspartic acid (SEAS), N-(2-sulfomethyl)-glutamic acid (SMGL), N-(2-sulfoethyl)-glutamic acid (SEGL), N-methyliminodiacetic acid (MIDA), α-alanine-N,N-diacetic acid (α-ALDA), serine-N,N-diacetic acid (SEDA), isoserine-N,N-diacetic acid (ISDA), phenylalanine-N,N-diacetic acid (PHDA), anthranilic acid-N,N-diacetic acid (ANDA), sulfanilic acid-N,N-diacetic acid (SLDA), taurine-N,N-diacetic acid (TUDA) and sulfomethyl-N,N-diacetic acid (SMDA), N-(2-hydroxyethyl)-ethylidenediamine-N, N, N′-triacetate (HEDTA), diethanolglycine (DEG), diethylenetriamine penta(methylenephosphonic acid) (DTPMP), aminotris(methylenephosphonic acid) (ATMP), and combinations and salts thereof. Further exemplary builders and/or co-builders are described in, e.g., WO 09/102854, U.S. Pat. No. 5,977,053

### Bleaching Systems

The detergent may contain 0-45% by weight, such as about 0% to about 30%, of a bleaching system. Any bleaching system known in the art for use in laundry detergents may be utilized. Suitable bleaching system components include bleaching catalysts, photobleaches, bleach activators, sources of hydrogen peroxide such as sodium percarbonate and sodium perborates, preformed peracids and mixtures thereof. Suitable preformed peracids include, but are not limited to, peroxycarboxylic acids and salts, percarbonic acids and salts, perimidic acids and salts, peroxymonosulfuric acids and salts, for example, Oxone (R), and mixtures thereof. Non-limiting examples of bleaching systems include peroxide-based bleaching systems, which may comprise, for example, an inorganic salt, including alkali metal salts such as sodium salts of perborate (usually mono- or tetra-hydrate), percarbonate, persulfate, perphosphate, persilicate salts, in combination with a peracid-forming bleach activator. The term bleach activator is meant herein as a compound which reacts with peroxygen bleach like hydrogen peroxide to form a peracid. The peracid thus formed constitutes the activated bleach. Suitable bleach activators to be used herein include those belonging to the class of esters amides, imides or anhydrides. Suitable examples are tetracetylethylene diamine (TAED), sodium 4-[(3,5,5-trimethylhexanoyl)oxy]benzene sulfonate (ISONOBS), diperoxy dodecanoic acid, 4-(dodecanoyloxy)benzenesulfonate (LOBS), 4-(decanoyloxy)benzenesulfonate, 4-(decanoyloxy)benzoate (DOBS), 4-(nonanoyloxy)-benzenesulfonate (NOBS), and/or those disclosed in WO98/17767. A particular family of bleach activators of interest was disclosed in EP624154 and particularly preferred in that family is acetyl triethyl citrate (ATC). ATC or a short chain triglyceride like triacetin has the advantage that it is environmental friendly as it eventually degrades into citric acid and alcohol. Furthermore acetyl triethyl citrate and triacetin has a good hydrolytical stability in the product upon storage and it is an efficient bleach activator. Finally ATC provides a good building capacity to the laundry additive. Alternatively, the bleaching system may comprise peroxyacids of, for example, the amide, imide, or sulfone type. The bleaching system may also comprise peracids such as 6-(phthalimido)peroxyhexanoic acid (PAP). The bleaching system may also include a bleach catalyst. In some embodiments the bleach component may be an organic catalyst selected from the group consisting of organic catalysts having the following formulae:

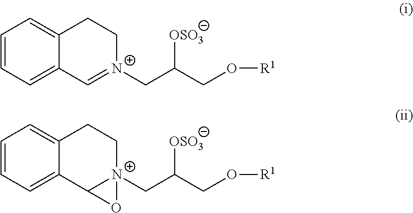

(iii) and mixtures thereof; wherein each R¹ is independently a branched alkyl group containing from 9 to 24 carbons or linear alkyl group containing from 11 to 24 carbons, preferably each R¹ is independently a branched alkyl group containing from 9 to 18 carbons or linear alkyl group containing from 11 to 18 carbons, more preferably each R¹ is independently selected from the group consisting of 2-propylheptyl, 2-butyloctyl, 2-pentylnonyl, 2-hexyldecyl, n-dodecyl, n-tetradecyl, n-hexadecyl, n-octadecyl, iso-nonyl, iso-decyl, iso-tridecyl and iso-pentadecyl. Other exemplary bleaching systems are described, e.g. in WO2007/087258, WO2007/087244, WO2007/087259 and WO2007/087242. Suitable photobleaches may for example be sulfonated zinc phthalocyanine

### Polymers

The detergent may contain 0-10% by weight, such as 0.5-5%, 2-5%, 0.5-2% or 0.2-1% of a polymer. Any polymer known in the art for use in detergents may be utilized. The polymer may function as a co-builder as mentioned above, or may provide antiredeposition, fiber protection, soil release, dye transfer inhibition, grease cleaning and/or anti-foaming properties. Some polymers may have more than one of the above-mentioned properties and/or more than one of the below-mentioned motifs. Exemplary polymers include (carboxymethyl)cellulose (CMC), poly(vinyl alcohol) (PVA), poly(vinylpyrrolidone) (PVP), poly(ethyleneglycol) or poly(ethylene oxide) (PEG), ethoxylated poly(ethyleneimine), carboxymethyl inulin (CMI), and polycarboxylates such as PAA, PAA/PMA, poly-aspartic acid, and lauryl methacrylate/acrylic acid copolymers, hydrophobically modified CMC (HM-CMC) and silicones, copolymers of terephthalic acid and oligomeric glycols, copolymers of poly(ethylene terephthalate) and poly(oxyethene terephthalate) (PET-POET), PVP, poly(vinylimidazole) (PVI), poly(vinylpyridine-N-oxide) (PVPO or PVPNO) and polyvinylpyrrolidone-vinylimidazole (PVPVI). Further exemplary polymers include sulfonated polycarboxylates, polyethylene oxide and polypropylene oxide (PEO-PPO) and diquaternium ethoxy sulfate. Other exemplary polymers are disclosed in, e.g., WO 2006/130575. Salts of the above-mentioned polymers are also contemplated.

### Fabric Hueing Agents

The detergent compositions of the present invention may also include fabric hueing agents such as dyes or pigments, which when formulated in detergent compositions can deposit onto a fabric when said fabric is contacted with a wash liquor comprising said detergent compositions and thus altering the tint of said fabric through absorption/reflection of visible light. Fluorescent whitening agents emit at least some visible light. In contrast, fabric hueing agents alter the tint of a surface as they absorb at least a portion of the visible light spectrum. Suitable fabric hueing agents include dyes and dye-clay conjugates, and may also include pigments. Suitable dyes include small molecule dyes and polymeric dyes. Suitable small molecule dyes include small molecule dyes selected from the group consisting of dyes falling into the Colour Index (C.I.) classifications of Direct Blue, Direct Red, Direct Violet, Acid Blue, Acid Red, Acid Violet, Basic Blue, Basic Violet and Basic Red, or mixtures thereof, for example as described in WO 2005/03274, WO 2005/03275, WO 2005/03276 and EP 1876226 (hereby incorporated by reference). The detergent composition preferably comprises from about 0.00003 wt % to about 0.2 wt %, from about 0.00008 wt % to about 0.05 wt %, or even from about 0.0001 wt % to about 0.04 wt % fabric hueing agent. The composition may comprise from 0.0001 wt % to 0.2 wt % fabric hueing agent, this may be especially preferred when the composition is in the form of a unit dose pouch. Suitable hueing agents are also disclosed in, e.g. WO 2007/087257 and WO 2007/087243.

### Adjunct Materials

Any detergent components known in the art for use in laundry detergents may also be utilized. Other optional detergent components include anti-corrosion agents, anti-shrink agents, anti-soil redeposition agents, anti-wrinkling agents, bactericides, binders, corrosion inhibitors, disintegrants/disintegration agents, dyes, enzyme stabilizers (including boric acid, borates, CMC, and/or polyols such as propylene glycol), fabric conditioners including clays, fillers/processing aids, fluorescent whitening agents/optical brighteners, foam boosters, foam (suds) regulators, perfumes, soil-suspending agents, softeners, suds suppressors, tarnish inhibitors, and wicking agents, either alone or in combination. Any ingredient known in the art for use in laundry detergents may be utilized. The choice of such ingredients is well known within the skill of the artisan.

Dispersants—The detergent compositions of the present invention can also contain dispersants. In particular powdered detergents may comprise dispersants. Suitable water-soluble organic materials include the homo- or co-polymeric acids or their salts, in which the polycarboxylic acid comprises at least two carboxyl radicals separated from each other by not more than two carbon atoms. Suitable dispersants are for example described in Powdered Detergents, Surfactant science series volume 71, Marcel Dekker, Inc.
Dye Transfer Inhibiting Agents—The detergent compositions of the present invention may also include one or more dye transfer inhibiting agents. Suitable polymeric dye transfer inhibiting agents include, but are not limited to, polyvinylpyrrolidone polymers, polyamine N-oxide polymers, copolymers of N-vinylpyrrolidone and N-vinylimidazole, polyvinyloxazolidones and polyvinylimidazoles or mixtures thereof. When present in a subject composition, the dye transfer inhibiting agents may be present at levels from about 0.0001% to about 10%, from about 0.01% to about 5% or even from about 0.1% to about 3% by weight of the composition.
Fluorescent whitening agent—The detergent compositions of the present invention will preferably also contain additional components that may tint articles being cleaned, such as fluorescent whitening agent or optical brighteners. Where present the brightener is preferably at a level of about 0.01% to about 0.5%. Any fluorescent whitening agent suitable for use in a laundry detergent composition may be used in the composition of the present invention. The most commonly used fluorescent whitening agents are those belonging to the classes of diaminostilbene-sulfonic acid derivatives, diarylpyrazoline derivatives and bisphenyl-distyryl derivatives. Examples of the diaminostilbene-sulfonic acid derivative type of fluorescent whitening agents include the sodium salts of: 4,4′-bis-(2-diethanolamino-4-anilino-s-triazin-6-ylamino) stilbene-2,2′-disulfonate, 4,4′-bis-(2,4-dianilino-s-triazin-6-ylamino) stilbene-2.2′-disulfonate, 4,4′-bis-(2-anilino-4-(N-methyl-N-2-hydroxy-ethylamino)-s-triazin-6-ylamino) stilbene-2,2′-disulfonate, 4,4′-bis-(4-phenyl-1,2,3-triazol-2-yl)stilbene-2,2′-disulfonate and sodium 5-(2H-naphtho[1,2-d][1,2,3]triazol-2-yl)-2-[(E)-2-phenylvinyl]benzenesulfonate. Preferred fluorescent whitening agents are Tinopal DMS and Tinopal CBS available from Ciba-Geigy AG, Basel, Switzerland. Tinopal DMS is the disodium salt of 4,4′-bis-(2-morpholino-4-anilino-s-triazin-6-ylamino) stilbene-2,2′-disulfonate. Tinopal CBS is the disodium salt of 2,2′-bis-(phenyl-styryl)-disulfonate. Also preferred are fluorescent whitening agents is the commercially available Parawhite KX, supplied by Paramount Minerals and Chemicals, Mumbai, India. Other fluorescers suitable for use in the invention include the 1-3-diaryl pyrazolines and the 7-alkylaminocoumarins.

Suitable fluorescent brightener levels include lower levels of from about 0.01, from 0.05, from about 0.1 or even from about 0.2 wt % to upper levels of 0.5 or even 0.75 wt %.

Soil release polymers—The detergent compositions of the present invention may also include one or more soil release polymers which aid the removal of soils from fabrics such as cotton and polyester based fabrics, in particular the removal of hydrophobic soils from polyester based fabrics. The soil release polymers may for example be nonionic or anionic terephthalte based polymers, polyvinyl caprolactam and related copolymers, vinyl graft copolymers, polyester polyamides see for example Chapter 7 in Powdered Detergents, Surfactant science series volume 71, Marcel Dekker, Inc. Another type of soil release polymers are amphiphilic alkoxylated grease cleaning polymers comprising a core structure and a plurality of alkoxylate groups attached to that core structure. The core structure may comprise a polyalkylenimine structure or a polyalkanolamine structure as described in detail in WO 2009/087523 (hereby incorporated by reference). Furthermore random graft co-polymers are suitable soil release polymers. Suitable graft co-polymers are described in more detail in WO 2007/138054, WO 2006/108856 and WO 2006/113314 (hereby incorporated by reference). Other soil release polymers are substituted polysaccharide structures especially substituted cellulosic structures such as modified cellulose deriviatives such as those described in EP 1867808 or WO 2003/040279 (both are hereby incorporated by reference). Suitable cellulosic polymers include cellulose, cellulose ethers, cellulose esters, cellulose amides and mixtures thereof. Suitable cellulosic polymers include anionically modified cellulose, nonionically modified cellulose, cationically modified cellulose, zwitterionically modified cellulose, and mixtures thereof. Suitable cellulosic polymers include methyl cellulose, carboxy methyl cellulose, ethyl cellulose, hydroxyl ethyl cellulose, hydroxyl propyl methyl cellulose, ester carboxy methyl cellulose, and mixtures thereof.
Anti-redeposition agents—The detergent compositions of the present invention may also include one or more anti-redeposition agents such as carboxymethylcellulose (CMC), polyvinyl alcohol (PVA), polyvinylpyrrolidone (PVP), polyoxyethylene and/or polyethyleneglycol (PEG), homopolymers of acrylic acid, copolymers of acrylic acid and maleic acid, and ethoxylated polyethyleneimines. The cellulose based polymers described under soil release polymers above may also function as anti-redeposition agents.
Other suitable adjunct materials include, but are not limited to, anti-shrink agents, anti-wrinkling agents, bactericides, binders, carriers, dyes, enzyme stabilizers, fabric softeners, fillers, foam regulators, hydrotropes, perfumes, pigments, sod suppressors, solvents, and structurants for liquid detergents and/or structure elasticizing agents.

### Formulation of Detergent Products

The detergent composition of the invention may be in any convenient form, e.g., a bar, a homogenous tablet, a tablet having two or more layers, a pouch having one or more compartments, a regular or compact powder, a granule, a paste, a gel, or a regular, compact or concentrated liquid.

Detergent formulation forms: Layers (same or different phases), Pouches, versus forms for Machine dosing unit.

Pouches can be configured as single or multicompartments. It can be of any form, shape and material which is suitable for hold the composition, e.g. without allowing the release of the composition to release of the composition from the pouch prior to water contact. The pouch is made from water soluble film which encloses an inner volume. Said inner volume can be divided into compartments of the pouch. Preferred films are polymeric materials preferably polymers which are formed into a film or sheet. Preferred polymers, copolymers or derivates thereof are selected polyacrylates, and water soluble acrylate copolymers, methyl cellulose, carboxy methyl cellulose, sodium dextrin, ethyl cellulose, hydroxyethyl cellulose, hydroxypropyl methyl cellulose, malto dextrin, poly methacrylates, most preferably polyvinyl alcohol copolymers and, hydroxypropyl methyl cellulose (HPMC). Preferably the level of polymer in the film for example PVA is at least about 60%. Preferred average molecular weight will typically be about 20,000 to about 150,000. Films can also be of blended compositions comprising hydrolytically degradable and water soluble polymer blends such as polylactide and polyvinyl alcohol (known under the Trade reference M8630 as sold by MonoSol LLC, Indiana, USA) plus plasticisers like glycerol, ethylene glycerol, propylene glycol, sorbitol and mixtures thereof. The pouches can comprise a solid laundry cleaning composition or part components and/or a liquid cleaning composition or part components separated by the water soluble film. The compartment for liquid components can be different in composition than compartments containing solids. Ref: (US2009/0011970 A1).

Detergent ingredients can be separated physically from each other by compartments in water dissolvable pouches or in different layers of tablets. Thereby negative storage interaction between components can be avoided. Different dissolution profiles of each of the compartments can also give rise to delayed dissolution of selected components in the wash solution.

A liquid or gel detergent, which is not unit dosed, may be aqueous, typically containing at least 10% by weight and up to 95% water, such as up to about 70% water, up to about 65% water, up to about 55% water, up to about 45% water, up to about 35% water. Other types of liquids, including without limitation, alkanols, amines, diols, ethers and polyols may be included in an aqueous liquid or gel. An aqueous liquid or gel detergent may contain from 0-30% organic solvent.

A liquid or gel detergent may be non-aqueous.

The invention is further summarized in the below paragraphs:

1. A method for cleaning or laundering textiles and/or fabrics comprising the steps of:
a. Providing a wash liquor by dissolving/mixing a detergent composition and a multi enzyme composition in water;
b. Washing an aliquot of fabrics/textile in the wash liquor;
c. Repeating step b. one or more times with a new aliquot of fabrics/textiles so that the wash liquor is used for 2 or more times; and
d. Optionally rinsing and drying the fabrics/textiles.
   2. The method of paragraph 1, wherein the detergent composition and the multi enzyme composition is provided as one composition.
   3. The method of paragraph 1 or 2, wherein the detergent composition comprises one or more ingredients selected among surfactants, builders, polymers, pH regulating agents, bleaching agents, hueing agents, optical brighteners, perfume and color.
   4. The method of any of the paragraphs 1-3, wherein the multi enzyme composition comprises at least two different enzymes selected among proteases, amylases cellulases, mannanases, lipases, cutinases, pectinases, peroxydases, xanthanases and xyloglucanases.
   5. The method of paragraph 4, wherein the multi enzyme composition comprises at least three enzymes, preferably at least 4 enzymes, preferably at least 5 enzymes, preferably at least 6 enzymes, preferably at least 7 enzymes or at least 8 enzymes.
   6. The method of any of the previous paragraphs, wherein the multi enzyme composition comprises a protease, an amylase, a lipase, a pectate lyase and a cellulase.
   7. The method of any of the previous paragraphs, wherein one or more enzymes are selected among:
i) Alkaline proteases having at least 90% identity to the amino acid sequence of subtilisin 309 as disclosed in EP 396608 or variants described in WO 92/19729, WO 98/20115, WO 98/20116, and WO 98/34946, especially the variants with substitutions in one or more of the following positions: 27, 36, 57, 76, 87, 97, 101, 104, 120, 123, 167, 170, 194, 206, 218, 222, 224, 235, and 274;
ii) Amylases or variants described in WO 94/02597, WO 94/18314, WO 96/23873, and WO 97/43424, especially the variants with substitutions in one or more of the following positions: 15, 23, 105, 106, 124, 128, 133, 154, 156, 181, 188, 190, 197, 202, 208, 209, 243, 264, 304, 305, 391, 408, and 444; or alpha-amylase having SEQ ID NO: 12 in WO 01/66712 or a variant having at least 80% sequence identity to SEQ ID NO: 12 and having a substitution, a deletion or an insertion of one amino acids downstream for the amino acid corresponding to the positions in the amylase having SEQ ID NO: 12 in WO 01/66712: R28, R118, N174; R181, G182, D183, G184, G186, W189, N195, M202, Y298, N299, K302, S303, N306, R310, N314; R320, H324, E345, Y396, R400, W439, R444, N445, K446, Q449, R458, N471, N484; Particular preferred amylases include such a variant having a deletion of D183 and G184 and having the substitutions R118K, N195F, R320K and R458K and a variant additionally having substitutions in one or more positions selected from the group: M9, G149, G182, G186, M202, T257, Y295, N299, M323, A339 and E345, most preferred a variant additionally having substitutions in all these positions; or a variant alpha-amylase derived from a parent α-amylase derived from B. licheniformis comprising the mutation: A1*+N2*+L3V+M15T+R23K+S29A+A30E+Y31H+A33S+E34D+H35I+M197T;
iii) cellulases having a sequence of at least 97% identity to the amino acid sequence of position 1 to position 773 of SEQ ID NO:2 in WO 02/099091, or a variant thereof having substitution, insertion and/or deletion at one or more of the positions corresponding to the following positions in SEQ ID NO: 8 of WO 02/099091: 2, 4, 7, 8, 10, 13, 15, 19, 20, 21, 25, 26, 29, 32, 33, 34, 35, 37, 40, 42, 42a, 43, 44, 48, 53, 54, 55, 58, 59, 63, 64, 65, 66, 67, 70, 72, 76, 79, 80, 82, 84, 86, 88, 90, 91, 93, 95, 95d, 95h, 95j, 97, 100, 101, 102, 103, 113, 114, 117, 119, 121, 133, 136, 137, 138, 139, 140a, 141, 143a, 145, 146, 147, 150e, 150j, 151, 152, 153, 154, 155, 156, 157, 158, 159, 160c, 160e, 160k, 161, 162, 164, 165, 168, 170, 171, 172, 173, 175, 176, 178, 181, 183, 184, 185, 186, 188, 191, 192, 195, 196, 200, and/or 20, preferably selected among P19A, G20K, Q44K, N48E, Q119H or Q146 R;
iv) lipase from Thermomyces, e.g., from T. lanuginosus (previously named Humicola lanuginosa) as described in EP 258 068 and EP 305 216, cutinase from Humi-cola, e.g. H. insolens as described in WO 96/13580, a Pseudomonas lipase, e.g., from P. alcaligenes or P. pseudoalcaligenes (EP 218 272), P. cepacia (EP 331 376), P. stutzeri (GB 1,372,034), P. fluorescens, Pseudomonas sp. strain SD 705 (WO 95/06720 and WO 96/27002), P. wisconsinensis (WO 96/12012), a Bacillus lipase, e.g., from B. subtilis (Dartois et al., 1993, Biochemica et Biophysica Acta, 1131: 253-360), B. stearothermophilus (JP 64/744992) or B. pumilus (WO 91/16422); or lipase variants such as those described in WO 92/05249, WO 94/01541, EP 407 225, EP 260 105, WO 95/35381, WO 96/00292, WO 95/30744, WO 94/25578, WO 95/14783, WO 95/22615, WO 97/04079, WO 97/07202, WO 00/060063, WO 2007/087508 and WO 2009/109500;
v) xyloglucanases having at least 80% sequence identity to SEQ ID NO: 3 or WO 2009/147210, or a variant having a substitution, deletion or insertion in one or more of the positions 68, 123, 156, 118, 200, 129, 137, 193, 92, 83, 149, 34, 340, 332, 9, 76, 331, 310, 324, 498, 395, 366, 1, 374, 7, 140, 8, 14, 21, 211, 37, 45, 13, 78, 87, 436, 101, 104, 111, 306, 117, 119, 414, 139, 268, 142, 159, 164, 102, 168, 176, 180, 482, 183, 202, 206, 217, 4, 222, 19, 224, 228, 232, 2, 240, 244, 5, 247, 249, 328, 252, 259, 406, 267, 269, 275, 179, 166, 278, 281, 288, 298, 301, 18, 302, 165, 80, 303, 316, 169, 322, 120, 146, 342, 348, 147, 353, 380, 468, 382, 383, 38, 384, 389, 391, 10, 392, 396, 177, 397, 399, 409, 237, 413, 253, 415, 418, 40, 443, 445, 148, 449, 225, 450, 454, 3, 455, 456, 299, 461, 470, 204, 476, 488, 347, and 507, which position corresponds to a position in amino acid sequence SEQ ID NO:3 of WO 2009/147210, preferably selected among Q68H,N,L; S123P,T; R156Y,F,V,I,K,W,L,M; K118A,R; G200P,E,S,D; K129T,A,S; Q137E; H193T,S,D; T92V,I,A,S; A83E; Q149E; L34F,I,V; R340T,N; S332P; T9D; S76W,V,I,K,R,T; N331F,C; M310I,V,L; D324N; G498A,D; D395G and D366H;
vi) pectate lyases having at least 65% sequence identity to SEQ ID NO: 2 of WO 2003/095638 or a variant thereof having an alteration, such as a substitution, an insertion of an amino acids downstream of the position indicated or a deletion of the amino acid that occupies the position, at one or more positions selected from the group consisting of positions number: 5, 9, 11, 26, 28, 30, 31, 37, 40, 45, 46, 47, 48, 49, 50, 51, 52, 54, 61, 64, 68, 69, 70, 71, 74, 75, 76, 79, 86, 87, 91, 99, 105, 106, 107, 111, 115, 116, 118, 122, 123, 134, 136, 139, 140, 141, 146, 148, 156, 158, 170, 182, 185, 186, 189, 193, 194, 196, 199, 201, 202, 204, 213, 215, 218, 224, 228, 229, 234, 235, 237, 251, 256, 257, 258, 272, 277, 286, 295, 298, 301, 302, 303, 305, 307, 308, 314, 316, 323, 324, 326, 331, 332, 333, 334, 335, 336, 337, 338, 339, 340, 341, 349, 356, 357, 363, 366, 378, 381, 384, 386, 387, 389, 390, 391, 393 and 397; or
vii) mannanases having a sequence that is at least 65% identical to SEQ ID NO: 2 of WO 99/64619.
   8. The method of any of the previous paragraphs, wherein the wash water is reused at least 2 times, such as at least 3 times, such as at least 4 times; such as at least 5 times, such as at least 6 times, such as at least 7 times, such as at least 8 times, such as at least 9 times, such as at least 10 times.
   9. A detergent composition for manual laundry, comprising a multi enzyme composition, wherein the multi enzyme composition comprises at least 2, preferably at least 3, preferably at least 4, preferably at least 5, preferably at least 6, preferably at least 7 and most preferred at least 8 enzymes selected among: proteases, amylases, cellulases, lipases, pectinases, mannanases, xanthanases, peroxidases and laccases.
   10. A multi enzyme composition comprising at least 2, preferably at least 3, preferably at least 4, preferably at least 5, preferably at least 6, preferably at least 7 and most preferred at least 8 enzymes selected among: proteases, amylases, cellulases, lipases, pectinases, mannanases, xanthanases, peroxidases and laccases.
   11. The multi enzyme composition of paragraph 10, wherein one or more enzymes are selected among:
i) Alkaline proteases having at least 90% identity to the amino acid sequence of subtilisin 309 as disclosed in EP 396608 or variants described in WO 92/19729, WO 98/20115, WO 98/20116, and WO 98/34946, especially the variants with substitutions in one or more of the following positions: 27, 36, 57, 76, 87, 97, 101, 104, 120, 123, 167, 170, 194, 206, 218, 222, 224, 235, and 274;
ii) Amylases or variants described in WO 94/02597, WO 94/18314, WO 96/23873, and WO 97/43424, especially the variants with substitutions in one or more of the following positions: 15, 23, 105, 106, 124, 128, 133, 154, 156, 181, 188, 190, 197, 202, 208, 209, 243, 264, 304, 305, 391, 408, and 444; or alpha-amylase having SEQ ID NO: 12 in WO 01/66712 or a variant having at least 80% sequence identity to SEQ ID NO: 12 and having a substitution, a deletion or an insertion of one amino acids downstream for the amino acid corresponding to the positions in the amylase having SEQ ID NO: 12 in WO 01/66712: R28, R118, N174; R181, G182, D183, G184, G186, W189, N195, M202, Y298, N299, K302, S303, N306, R310, N314; R320, H324, E345, Y396, R400, W439, R444, N445, K446, Q449, R458, N471, N484; Particular preferred amylases include such a variant having a deletion of D183 and G184 and having the substitutions R118K, N195F, R320K and R458K and a variant additionally having substitutions in one or more positions selected from the group: M9, G149, G182, G186, M202, T257, Y295, N299, M323, A339 and E345, most preferred a variant additionally having substitutions in all these positions; or a variant alpha-amylase derived from a parent α-amylase derived from B. licheniformis comprising the mutation: A1*+N2*+L3V+M15T+R23K+S29A+A30E+Y31H+A33S+E34D+H35I+M197T;
iii) cellulases having a sequence of at least 97% identity to the amino acid sequence of position 1 to position 773 of SEQ ID NO:2 in WO 02/099091, or a variant thereof having a substitution, insertion and/or deletion at one or more of the positions corresponding to the following positions in SEQ ID NO: 8 of WO 02/099091: 2, 4, 7, 8, 10, 13, 15, 19, 20, 21, 25, 26, 29, 32, 33, 34, 35, 37, 40, 42, 42a, 43, 44, 48, 53, 54, 55, 58, 59, 63, 64, 65, 66, 67, 70, 72, 76, 79, 80, 82, 84, 86, 88, 90, 91, 93, 95, 95d, 95h, 95j, 97, 100, 101, 102, 103, 113, 114, 117, 119, 121, 133, 136, 137, 138, 139, 140a, 141, 143a, 145, 146, 147, 150e, 150j, 151, 152, 153, 154, 155, 156, 157, 158, 159, 160c, 160e, 160k, 161, 162, 164, 165, 168, 170, 171, 172, 173, 175, 176, 178, 181, 183, 184, 185, 186, 188, 191, 192, 195, 196, 200, and/or 20, preferably selected among P19A, G20K, Q44K, N48E, Q119H or Q146 R;
iv) lipase from Thermomyces, e.g., from T. lanuginosus (previously named Humicola lanuginosa) as described in EP 258 068 and EP 305 216, cutinase from Humicola, e.g. H. insolens as described in WO 96/13580, a Pseudomonas lipase, e.g., from P. alcaligenes or P. pseudoalcaligenes (EP 218 272), P. cepacia (EP 331 376), P. stutzeri (GB 1,372,034), P. fluorescens, Pseudomonas sp. strain SD 705 (WO 95/06720 and WO 96/27002), P. wisconsinensis (WO 96/12012), a Bacillus lipase, e.g., from B. subtilis (Dartois et al., 1993, Biochemica et Biophysica Acta, 1131: 253-360), B. stearothermophilus (JP 64/744992) or B. pumilus (WO 91/16422); or lipase variants such as those described in WO 92/05249, WO 94/01541, EP 407 225, EP 260 105, WO 95/35381, WO 96/00292, WO 95/30744, WO 94/25578, WO 95/14783, WO 95/22615, WO 97/04079, WO 97/07202, WO 00/060063, WO 07/087508 and WO 09/109500;
v) xyloglucanases having at least 80% sequence identity to SEQ ID NO: 3 or WO 09/147210, or a variant having a substitution, deletion or insertion in one or more of the positions 68, 123, 156, 118, 200, 129, 137, 193, 92, 83, 149, 34, 340, 332, 9, 76, 331, 310, 324, 498, 395, 366, 1, 374, 7, 140, 8, 14, 21, 211, 37, 45, 13, 78, 87, 436, 101, 104, 111, 306, 117, 119, 414, 139, 268, 142, 159, 164, 102, 168, 176, 180, 482, 183, 202, 206, 217, 4, 222, 19, 224, 228, 232, 2, 240, 244, 5, 247, 249, 328, 252, 259, 406, 267, 269, 275, 179, 166, 278, 281, 288, 298, 301, 18, 302, 165, 80, 303, 316, 169, 322, 120, 146, 342, 348, 147, 353, 380, 468, 382, 383, 38, 384, 389, 391, 10, 392, 396, 177, 397, 399, 409, 237, 413, 253, 415, 418, 40, 443, 445, 148, 449, 225, 450, 454, 3, 455, 456, 299, 461, 470, 204, 476, 488, 347, and 507, which position corresponds to a position in amino acid sequence SEQ ID NO:3 of WO 09/147210, preferably selected among Q68H,N,L; S123P,T; R156Y,F,V,I,K,W,L,M; K118A,R; G200P,E,S,D; K129T,A,S; Q137E; H193T,S,D; T92V,I,A,S; A83E; Q149E; L34F,I,V; R340T,N; S332P; T9D; S76W,V,I,K,R,T; N331F,C; M310I,V,L; D324N; G498A,D; D395G and D366H;
vi) pectate lyases having at least 65% sequence identity to SEQ ID NO: 2 of WO 03/095638 or a variant thereof having an alteration, such as a substitution, an insertion of an amino acids downstream of the position indicated or a deletion of the amino acid that occupies the position, at one or more positions selected from the group consisting of positions number: 5, 9, 11, 26, 28, 30, 31, 37, 40, 45, 46, 47, 48, 49, 50, 51, 52, 54, 61, 64, 68, 69, 70, 71, 74, 75, 76, 79, 86, 87, 91, 99, 105, 106, 107, 111, 115, 116, 118, 122, 123, 134, 136, 139, 140, 141, 146, 148, 156, 158, 170, 182, 185, 186, 189, 193, 194, 196, 199, 201, 202, 204, 213, 215, 218, 224, 228, 229, 234, 235, 237, 251, 256, 257, 258, 272, 277, 286, 295, 298, 301, 302, 303, 305, 307, 308, 314, 316, 323, 324, 326, 331, 332, 333, 334, 335, 336, 337, 338, 339, 340, 341, 349, 356, 357, 363, 366, 378, 381, 384, 386, 387, 389, 390, 391, 393 and 397; or
vii) mannanases having a sequence that is at least 65% identical to SEQ ID NO: 2 of WO 99/64619.
   12. The multi enzyme composition of paragraph 11, comprising one or more enzymes selected among:
1) A protease comprising an amino acid sequence at least 90% identical to the amino acid sequence of subtilisin 309 as disclosed in EP 396608, wherein the methionine in position 222 is substituted with another amino acid residue;
2) A variant alpha-amylase derived from a parent α-amylase derived from B. licheniformis comprising the mutation: A1*+N2*+L3V+M15T+R23K+S29A+A30E+Y31H+A33S+E34D+H35I+M197T;
3) A variant alpha-amylase derived from a parent alpha-amylase having the sequence SEQ ID NO: 12 in WO 01/66712, the variant having a deletion of D183 and G184 and having the substitutions R118K, N195F, R320K and R458K and a variant additionally having substitutions in one or more positions selected from the group: M9, G149, G182, G186, M202, T257, Y295, N299, M323, A339 and E345, most preferred a variant that additionally having substitutions in all these positions; A lipase having at least 90% identity with the wild-type lipase derived from Humicola lanuginosa strain DSM 4109 and comprising the substitutions T231R and N233R;
4) A pectate lyase having at least 65% sequence identity to SEQ ID NO: 2 of WO 03/095638 or a variant thereof having an alteration, such as a substitution, an insertion of an amino acids downstream of the position indicated or a deletion of the amino acid that occupies the position, at one or more positions selected from the group consisting of positions number: 5, 9, 11, 26, 28, 30, 31, 37, 40, 45, 46, 47, 48, 49, 50, 51, 52, 54, 61, 64, 68, 69, 70, 71, 74, 75, 76, 79, 86, 87, 91, 99, 105, 106, 107, 111, 115, 116, 118, 122, 123, 134, 136, 139, 140, 141, 146, 148, 156, 158, 170, 182, 185, 186, 189, 193, 194, 196, 199, 201, 202, 204, 213, 215, 218, 224, 228, 229, 234, 235, 237, 251, 256, 257, 258, 272, 277, 286, 295, 298, 301, 302, 303, 305, 307, 308, 314, 316, 323, 324, 326, 331, 332, 333, 334, 335, 336, 337, 338, 339, 340, 341, 349, 356, 357, 363, 366, 378, 381, 384, 386, 387, 389, 390, 391, 393 and 397;
5) A cellulase having a sequence of at least 97% identity to the amino acid sequence of position 1 to position 773 of SEQ ID NO:2 in WO 02/099091, or a variant thereof substitution at one or more of the positions selected among P19A, G20K, Q44K, N48E, Q119H or Q146 R.
   13. The multi enzyme composition of paragraph 12 comprising one enzyme from each of 1) to 6).
   14. A use of a multi enzyme composition of paragraphs 9-12 to improve the cleaning benefit and/or the whiteness in a subsequent wash cycle, where the wash liquor from a previous wash cycle is reused.
   15. The use of paragraph 14, where the wash liquor is reused 2 times or more, such as 3 times or more, such as 4 times or more, such as 5 times or more, such as 6 times or more, such as 7 times or more, such as 8 times or more, such as 9 times or more or 10 times or more.

### EXAMPLES

### Materials and Methods

### Swatches

Following swatches were used in the experiments: EMPA 116, CFT CS-28, CFT KC-H040 and Equest 123KC, Tomato puree Napolina. The swatches were purchased from Center For Testmaterials (CFT), The Netherlands.

### Multi Enzyme Composition (MEC):

The multi enzyme composition consisted or a mixture of commercial enzymes all available from Novozvmes A/S Bagsværd Denmark.

| | |
|---|---|
| Everlase 12 T | 50.00% |
| Duramyl 120 T | 15.00% |
| Stainzyme Plus 12 T | 7.50% |
| Lipex 100 T | 10.00% |
| Xpect 1000 T | 7.50% |
| Celluclean Clasic 700 T | 10.00% |

### Terg-O-Tometer (TOM) Wash Assay

The Tergo-To-Meter (TOM) is a medium scale model wash system that can be applied to test 12 different wash conditions simultaneously. A TOM is basically a large temperature controlled water bath with up to 12 open metal beakers submerged into it. Each beaker constitutes one small top loader style washing machine and during an experiment, each of them will contain a solution of a specific detergent/enzyme system and the soiled and unsoiled fabrics its performance is tested on. Mechanical stress is achieved by a rotating stirring arm, which stirs the liquid within each beaker. Because the TOM beakers have no lid, it is possible to withdraw samples during a TOM experiment and assay for information on-line during wash.

The TOM model wash system is mainly used in medium scale testing of detergents and enzymes at US or LA/AP (Latin America/Asia Pacific) wash conditions. In a TOM experiment, factors such as the ballast to soil ratio and the fabric to wash liquor ratio can be varied. Therefore, the TOM provides the link between small scale experiments, such as AMSA (WO 2002/042740) and mini-wash, and the more time consuming full scale experiments in top loader washing machines.

Equipment: The water bath with 12 steel beakers and 1 rotating arm per beaker with capacity of 500 or 1200 mL of detergent solution. Temperature ranges from 5 to 80° C. The water bath has to be filled up with deionised water. Rotational speed can be set up to 70 to 120 rpm/min.
1. Set temperature in the Terg-O-Tometer and start the rotation in the water bath. Wait for the temperature to adjust (tolerance is +/−0.5° C.)
2. All beakers shall be clean and without traces of prior test material.
3. Prepare wash solution with desired amount of detergent, temperature and water hardness in a bucket. Let detergent dissolve during magnet stirring for 10 min. Wash solution shall be used within 30 to 60 min after preparation.
4. Add 800 ml wash solution into a TOM beaker
5. Start agitation at 120 rpm and optionally add enzymes to the beaker.
6. Sprinkle the swatches into the beaker and then the ballast load.
7. Time measurement start when the swatches and ballast are added to the beaker.
8. Wash for 20 minutes
9. Stop agitation
10. Transfer the wash load from TOM beaker to a sieve and rinse with cold tap water
11. Separate the soil swatches from the ballast load. The soil swatches are transferred to a 5 L beaker with cold tap water under running water. Keep the ballast load separately for the coming inactivation.
12. Set the timer to 5 minutes.
13. Press gently the water out by hand and place the test swatches on a tray covered with a paper. Add another paper on top of the swatches.
14. Let the swatches dry over night and then measure at the Color Eye as described below.

### Example 1

### TOM Wash with Re-Use of Water

The four swatches EMPA 116, CFT CS-28, CFT KC-H040 and Equest 123KC, Tomato puree Napolina (three of each) were washed in TOM at a temperature of 25° C., water hardness 15° dH and 5 g/l of detergent. After washing in TOM the swatches were removed and kept for measuring the wash efficiency using the Color Eye.

The washing water was kept for a following wash cycle using fresh soiled swatches. This was done twice, giving a total of 3 sets of washed swatches (first wash in fresh water and 2 washed with recycled water).

The experiments were done with two different commercial detergents with or without adding multi enzyme composition. Thus following combinations were tested:

Commercial detergent 1 without enzymes

Commercial detergent 1 with 0.5% MEC

Commercial detergent 2 without enzymes

Commercial detergent 2 with 0.5% MEC

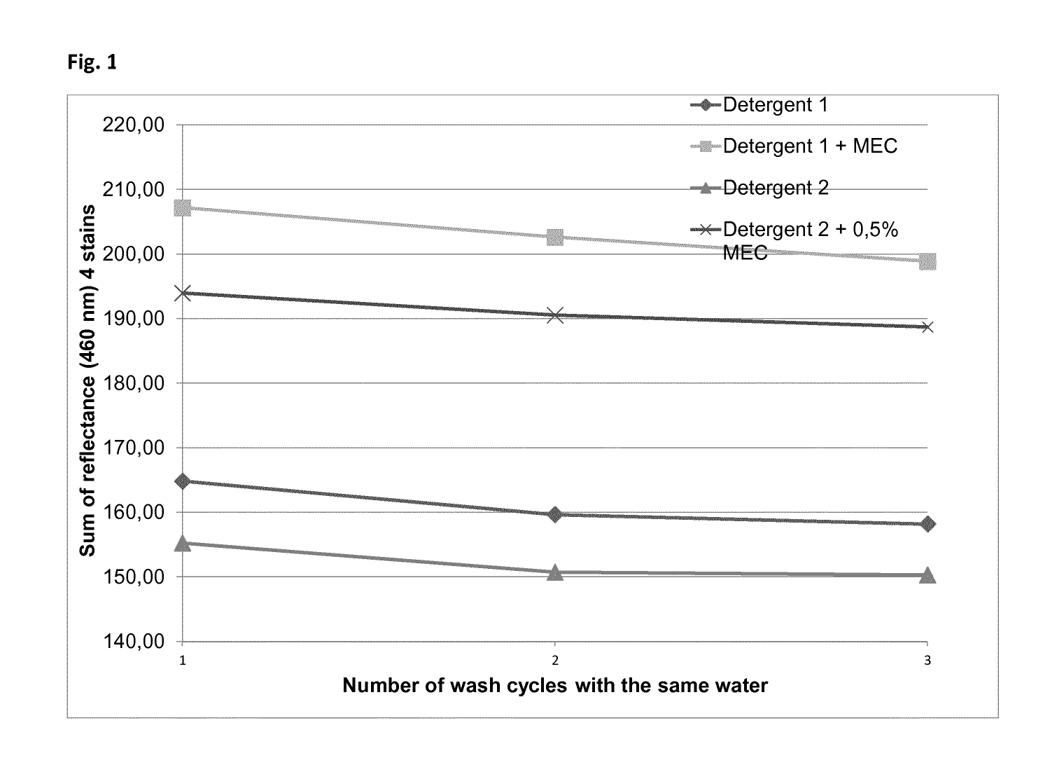

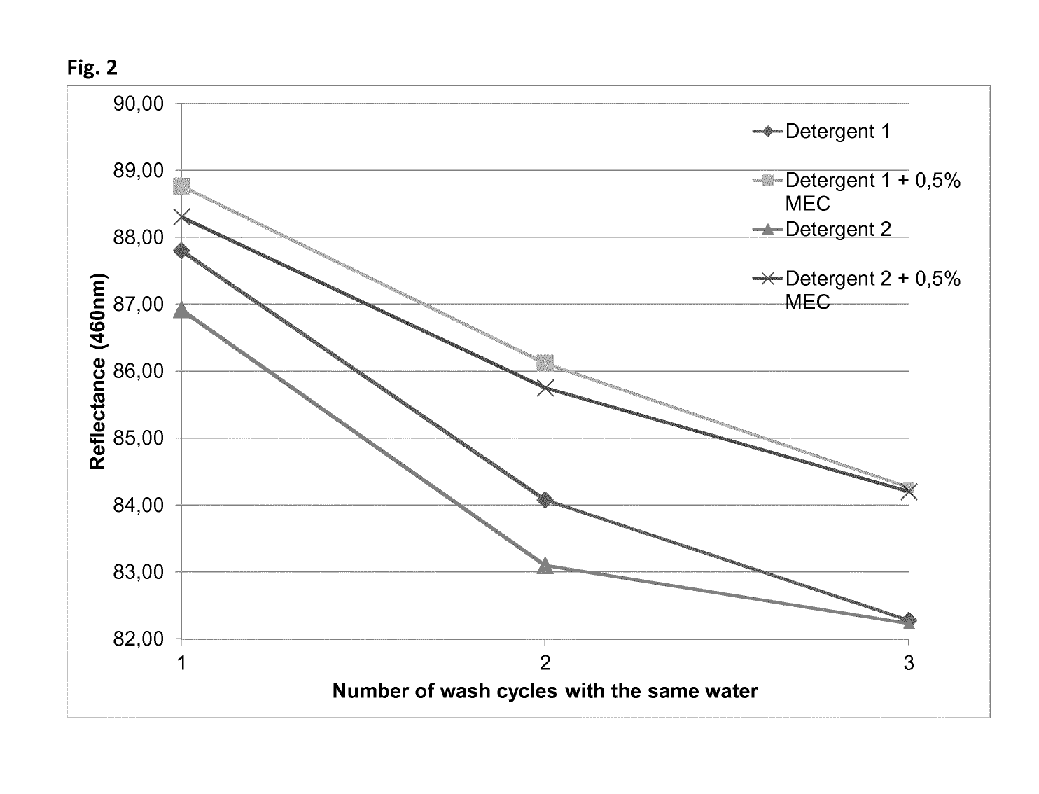

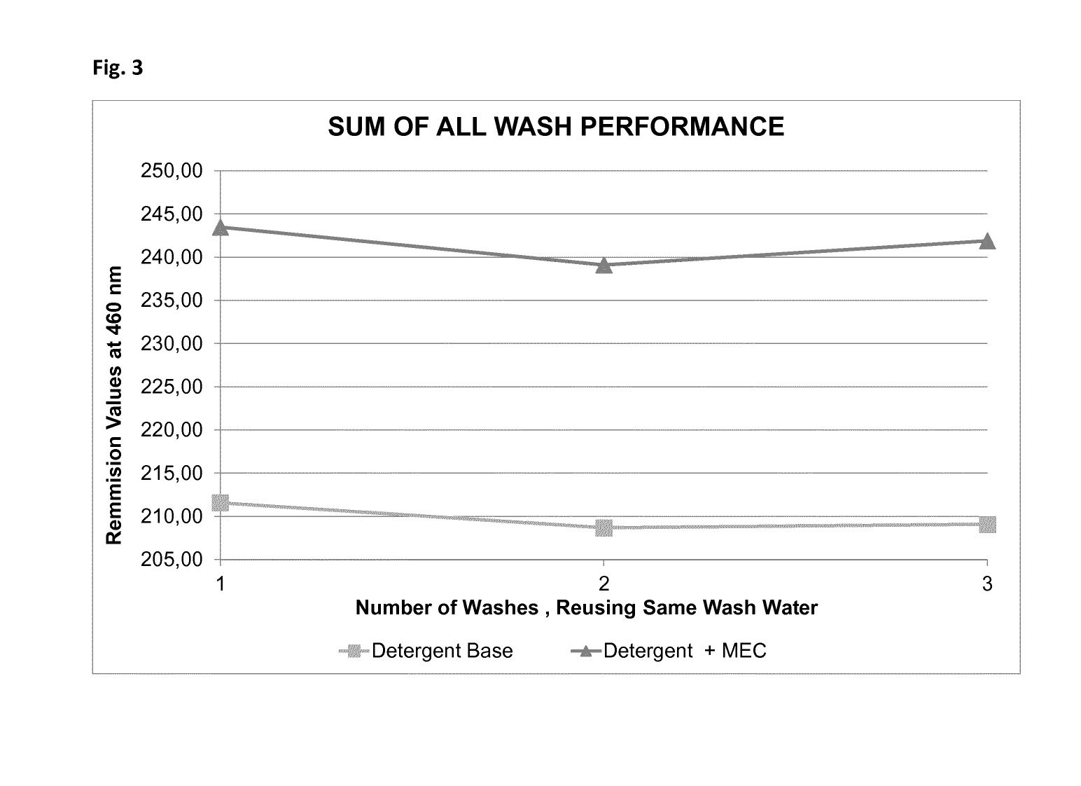

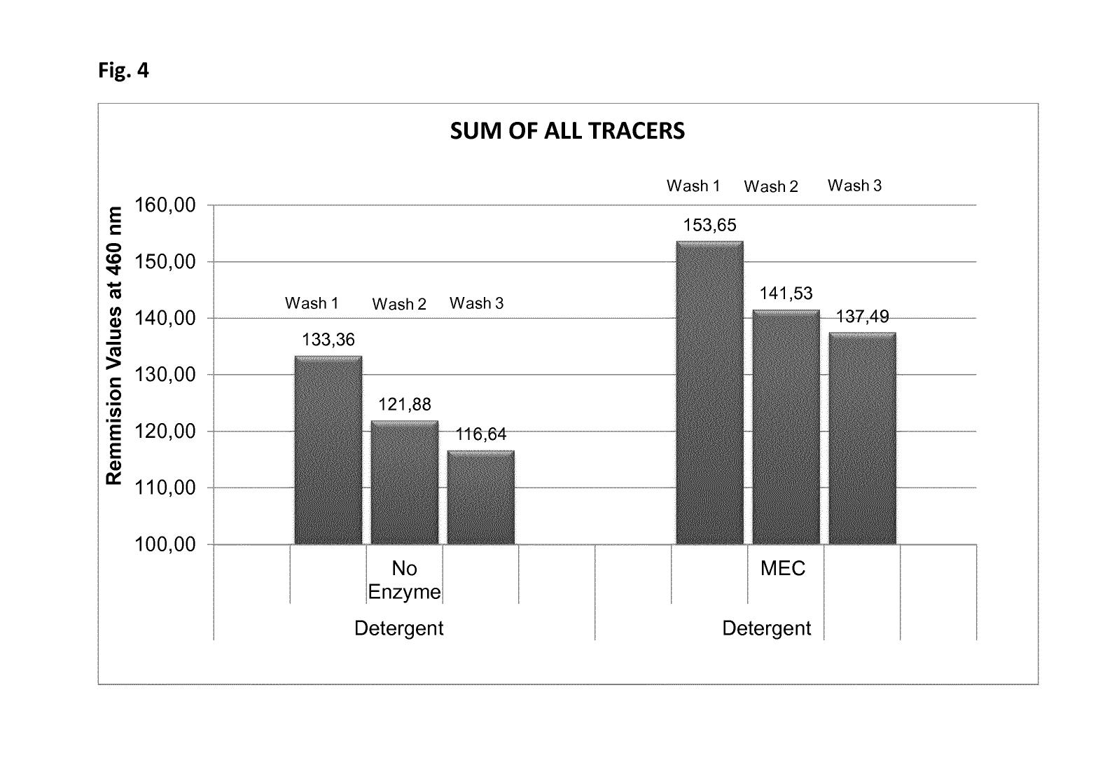

All experiments were done in duplicate. After the wash the wash performance was evaluated by measuring the reflectance at 460 nm, results shown in FIG. 1. The results showed an improved wash efficiency even in the third wash cycle. Further by measuring remission on the white area surrounding the spots (“off spot” measurement) it could also be seen that whiteness also was improved even in the third wash cycle (FIG. 2).

### Example 2

### TOM Wash with Re-Use of Water

The five swatches EMPA 116, CFT CS-28, CFT CS-10 CFT KC-H040 and Equest 123KC, Tomato puree Napolina (three of each) were washed in TOM at a temperature of 25° C., water hardness 25° dH and 5 g/l of detergent. After washing in TOM the swatches were removed and kept for measuring the wash efficiency using the Color Eye.

The washing water was kept for a following wash cycle using fresh soiled swatches. This was done twice, giving a total of 3 sets of washed swatches (first wash in fresh water and 2 washed with recycled water).

The experiments were done with one commercial detergent with or without adding multi enzyme composition. Thus following combinations were tested:

Commercial detergent without enzymes

Commercial detergent with 0.5% MEC

All experiments were done in duplicate. After the wash the wash performance was evaluated by measuring the reflectance at 460 nm, results shown in FIG. 3. The results showed an improved wash efficiency even in the third wash cycle.

### Example 3

### TOM Wash with Re-Use of Water

The four whiteness tracers EMPA 221, CFT PN1, CFT PCN 1, CFT CN-42 (three of each) were washed in TOM at a temperature of 25° C., water hardness 25° dH and 5 g/l of detergent. 5 g/l carbon black was added to first wash as an additional dispersed soil. After washing in TOM the swatches were removed dried and measured the whiteness efficiency using the Color Eye.

The washing water was kept for a following wash cycle using same whiteness tracers. This was done twice, giving a total of 3 sets of washed tracers (first wash in fresh water and 2 washed with recycled water).

The experiments were done with one commercial detergent with or without adding multi enzyme composition. Thus following combinations were tested:

Commercial detergent without enzymes

Commercial detergent with 0.5% MEC

All experiments were done in duplicate. Whiteness performance was evaluated by measuring the reflectance at 460 nm, results shown in FIG. 4. The results showed improved whiteness efficiency even in the third wash cycle.

1-16. (canceled)

17. A method for cleaning or laundering textiles and/or fabrics comprising the steps of:
a. Providing a wash liquor by dissolving/mixing a detergent composition and a multi enzyme composition in water;
b. Washing an aliquot of fabrics/textile in the wash liquor; and
c. Repeating step b. one or more times with a new aliquot of fabrics/textiles so that the wash liquor is used for 2 or more times.

18. The method of claim 17, further comprising rinsing and drying the fabrics/textiles.

19. The method of claim 17, wherein the detergent composition and the multi enzyme composition is provided as one composition.

20. The method of claim 17, wherein the detergent composition comprises one or more ingredients selected among surfactants, builders, polymers, pH regulating agents, bleaching agents, hueing agents, optical brighteners, perfume and color.

21. The method of claim 17, wherein the multi enzyme composition comprises at least two different enzymes selected among proteases, amylases cellulases, mannanases, lipases, cutinases, pectinases, peroxydases, xanthanases, pectate lyases and xyloglucanases.

22. The method of claim 21, wherein the multi enzyme composition comprises at least three enzymes.

23. The method of claim 17, wherein the multi enzyme composition comprises at least one protease, at least one amylase, at least one lipase, at least one pectate lyase and at least one cellulase.

24. The method of claim 17, wherein the multi enzyme composition comprises a protease, an amylase, a lipase, a pectate lyase and a cellulase.

25. The method of claim 17, wherein the wash water is reused at least 2 times.

26. A detergent composition for manual laundry, comprising a surfactant and a multi enzyme composition, wherein the multi enzyme composition comprises at least 2 enzymes selected from the group consisting of amylases, cellulases, laccases, lipases, pectinases, mannanases, pectate lyases, peroxidases, proteases, and xanthanases.
